(19) United States
(12) Patent Application Publication
(10) Pub. No.: US 2024/0073963 A1
(43) Pub. Date: Feb. 29, 2024

(54) Network Device, Terminal Device, and Methods Therein

(71) Applicant: Telefonaktiebolaget LM Ericsson (publ), Stockholm (SE)

(72) Inventors: Zhipeng Lin, Nanjing Jiangsu (CN); Talha Khan, Santa Clara, CA (US); Xingqin Lin, San José, CA (US); Jonas Sedin, Sollentuna (SE)

(21) Appl. No.: 18/268,350

(22) PCT Filed: Dec. 7, 2021
(86) PCT No.: PCT/CN2021/136033

§ 371 Date: Jun. 20, 2023

(30) Foreign Application Priority Data
Dec. 22, 2020 (WO) PCT/CN2020/138392

(51) Int. Cl. H04W 74/08; H04W 74/00

(52) U.S. Cl. CPC H04W 74/0833; H04W 74/006

(57) ABSTRACT

The present disclosure provides a method (1300) in a network device. The method (1300) includes: determining (s1310) a RACH configuration according to at least one random access procedure, wherein the RACH configuration comprises a preamble mapping indication indicating mapping of RACH preambles to SSBs and a SSB mapping indication indicating mapping of SSBs to ROs; transmitting (s1320) the RACH configuration; and receiving (s1330) a RACH preamble which is transmitted according to the RACH configuration from a terminal device.

### TECHNICAL FIELD

The present disclosure relates to wireless communication, and more particularly, to network devices, terminal devices and methods therein for random access procedures. Some aspects of the disclosure relates to random access channel (RACH) configuration that enables co-existence of at least two types of RACH procedures and enable resource sharing between at least two types of RACH procedures.

### BACKGROUND

1.1 New Radio Access

In 3GPP Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since Release 13 NB-IoT and LTE-M are part of the LTE specifications and provide connectivity to massive machine type communications (mMTC) services. In 3GPP Release 15, the first release of the 5G system (5GS) was specified. This is a new generation's radio access technology intended to serve use cases such as enhanced mobile broadband (eMBB), ultra-reliable and low latency communication (URLLC) and mMTC. 5G includes the New Radio (NR) access stratum interface and the 5G Core Network (5GC). The NR physical and higher layers are reusing parts of the LTE specification, and to that add needed components when motivated by new use cases. One such component is the introduction of a sophisticated framework for beam forming and beam management to extend the support of the 3GPP technologies to a frequency range going beyond 6 GHz.

In 3GPP Release 15, 3GPP started the work to prepare NR for operation in a Non-Terrestrial Network (NTN). The work was performed within the study item “NR to support Non-Terrestrial Networks” and resulted in “Study on New Radio (NR) to support non-terrestrial networks,” TR 38.811. In 3GPP Release 16, the work to prepare NR for operation in an NTN network continued with the study item “Solutions for NR to support Non-Terrestrial Networks”, TR 38.821. In parallel the interest to adapt NB-IoT and LTE-M for operation in NTN is growing. As a consequence, 3GPP Release 17 contains both a work item on NR NTN, “Solutions for NR to support non-terrestrial networks (NTN),” 3GPP RAN #86, RP-193234, and a study item on NB-IoT and LTE-M support for NTN, “Study on NB-Io/eMTC support for Non-Terrestrial Network,” 3GPP RAN #86, RP-193235.

1.2 Satellite Communications

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link that refers to the link between a satellite and a UE.

Depending on the orbit altitude, a satellite may be categorized as low earth orbit (LEO), medium earth orbit (MEO), or geostationary earth orbit (GEO) satellite:
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

A communication satellite typically generates several beams over a given area. The footprint of a beam is usually in an elliptic shape, which has been traditionally considered as a cell. The footprint of a beam is also often referred to as a spotbeam. The footprint of a beam may move over the earth surface with the satellite movement or may be earth-fixed with some beam pointing mechanism used by the satellite to compensate for its motion. The size of a spotbeam depends on the system design, which may range from tens of kilometers to a few thousands of kilometers.

FIG. 1 shows an illustrative architecture of a satellite network with bent pipe transponders. The depicted elevation angle of the service link is important as it determines the distance between the satellite and the device, and the velocity of the satellite relative the device. In 3GPP it has been assumed that the service link is operational for elevation angles exceeding a threshold of 10 degrees. Different locations within a cell will observe different elevation angles at a given time. From the network perspective the elevation angle is often referred to relative a reference point such as the spot beam center.

In an earth-fixed beam LEO or MEO NTN providing continuous coverage, a UE will be served by the same beam as long as the UE is in the coverage area of the satellite. Handover to a new satellite fulfilling the elevation angle threshold needs to be performed when the elevation angle to the currently serving satellite approaches the elevation angle threshold. The handover rate may be frequent, and it is shown in X. Lin et al., “5G New Radio Evolution Meets Satellite Communications: Opportunities, Challenges, and Solution,” arXiv preprint arXiv:1903.11219, March 2019 (available at https://arxiv.orq/pdf/1903.11219) that an inter-satellite handover may be required every 450 seconds for a LEO constellation at 600 km altitude.

For LEO or MEO constellations using earth moving beams the UE will be served by the beam that currently passes the UE location. The UE will sequentially be served by a series of beams of the same satellite as the coverage area of the satellite passes the UE. After that, the UE will be served by a series of beams of a different satellite, etc. Thus, switching between satellite beams is even more frequent. In X. Lin et al., “5G New Radio Evolution Meets Satellite Communications: Opportunities, Challenges, and Solution,” arXiv preprint arXiv:1903.11219, March 2019 (available at https://arxiv.org/pdf/1903.11219) it is shown that for a LEO constellation at 600 km altitude based on earth moving beams a handover between spotbeams may be required every 10 seconds.

Unlike the situation in terrestrial networks, the service link in NTN is typically line-of-sight (LoS) and therefore the pathloss is mainly dependent on the satellite-UE distance. Due to the geometry, the pathloss does not differ dramatically between the different beams of a satellite. E.g., a pathloss range in the order of 10 dB can be expected within the coverage area of a LEO satellite at 600 km altitude. The spotbeam selectivity is mainly due to the directivity of the antenna lobes. The antenna lobes are approximately symmetric around each beam's center point on earth. It may therefore be feasible that cell selection/reselection is based on which spotbeam center that is closest to the UE. The UE can calculate its distance to each beam center and perform distance-based cell selection/reselection using information of ephemeris and beam constellation of nearby NTN satellites together with UE location.

1.3 NR Cell Search and System Information Acquisition

In NR, the combination of synchronization signals (SS) and physical broadcast channel (PBCH) is referred to as a SS/PBCH block (SSB). Similar to LTE, a pair of SS, primary synchronization signal (PSS) and secondary synchronization signal (SSS), is periodically transmitted on downlink from each cell to allow a UE to initially access to the network. By detecting SS, a UE can obtain the physical cell identity, achieve downlink synchronization in both time and frequency, and acquire the timing for PBCH. PBCH carries the master information block (MIB), which contains a minimum system information that a UE is needed to acquire system information block 1 (SIB 1). SIB1 carries the remaining minimum system information that is needed for a UE to be able to perform subsequent random-access procedure.

Up to 4, 8, 64 SSBs, depending on the frequency range of the frequency band used, can be transmitted in one SSB period which can be 5 ms, 10 ms, 20 ms, 40 ms, 80 ms or 160 ms configured in SIB1, the default SSB period is 20 ms assumed for initial cell search since SIB1 is not available.

1.4 NR Random Access Procedure

Random access is performed by a terminal device, e.g., User Equipment (UE), in New Radio (NR) and Long Term Evolution (LTE) networks for accessing to a new cell. Once a random access procedure is completed, a terminal device can be connected to a network device, e.g., evolved NodeB (eNB) or gNB, and communicate with the network device using dedicated transmissions.

Two types of random access procedure are supported: 4-step random access type with Msg1 and 2-step random access type with MSGA. Both types of Random Access (RA) procedure support contention-based random access (CBRA) and contention-free random access (CFRA).

FIG. 2A shows a signaling sequence of a 4-step contention based random access procedure, also referred to as Type-1 random access procedure in TS 38.213. As shown, at 101, a UE detects a Synchronization Signal (SS) from a gNB. At 102, the UE decodes Master Information Block (MIB) and System Information Block (SIB) (i.e., Remaining Minimum System Information (RMSI) and Other System Information (OSI), which may be distributed over multiple physical channels such as Physical Broadcast Channel (PBCH) and Physical Downlink Shared Channel (PDSCH), to acquire random access transmission parameters. At 111, where the UE transmits a Physical Random Access Channel (PRACH) preamble, or Msg1, to the gNB. The gNB detects the Msg1 and responds with a Random Access Response (RAR), or Msg2, at 112. At 113, the UE transmits a Physical Uplink Shared Channel (PUSCH), or Msg3, to the gNB in accordance with configuration information for PUSCH transmission carried in the RAR. At 114, the gNB transmits a Contention Resolution Message, or Msg4, to the UE.

In the 4-step random access procedure as shown in FIG. 2A, the resource, including time resource and frequency resource, for PUSCH (i.e., Msg3) is indicated in the RAR (i.e., Msg2). In particular, the RAR contains an uplink grant including a 14-bit “PUSCH frequency resource allocation” field indicating the frequency domain resource for PUSCH and a 4-bit “PUSCH time resource allocation” field indicating the time domain resource for PUSCH.

There can be cases that multiple UEs select the same random-access preamble and transmit the preamble on the same PRACH time/frequency resource. This preamble collision is called contention. One of the main purposes of applying Step 113 and Step 114 is to resolve such potential contention.

In order to minimize the number of channel accesses, which is important for e.g. operations in unlicensed frequency bands where Listen Before Talk (LBT) is required before transmission, a 2-step random access procedure has also been proposed for NR. Instead of using the four steps 111-114, the 4-step random access procedure completes random access in only two steps with two messages, which may be referred to as Msg A and Msg B. FIG. 2B shows a signaling sequence of a 2-step contention based random access procedure, also referred to as Type-2 random access procedure in TS 38.213. As shown, the steps 101˜102 in FIG. 2B are the same as the steps 101˜102 in FIG. 2A. At 121, the UE transmits a PRACH preamble and a PUSCH in one message (i.e., Message A, msgA) to the gNB. The PUSCH may include higher layer data such as Radio Resource Control (RRC) connection request, possibly with some small additional payload. At 122, the gNB transmits Message B (msgB) to the UE, including UE identifier assignment, timing advance information and contention resolution message (CRM), etc.

FIG. 3A illustrates a 4-step random access type contention free random access, and FIG. 3B illustrates a 2-step random access type contention free random access. As shown in FIG. 3A, the network node 104 a preamble for CFRA in 4-step RACH, and, as shown in FIG. 3B, the network node 104 assigns a preamble and PUSCH for CFRA in 2-step RACH. The network node 104 does not configure CFRA resources for 4-step and 2-step RA types at the same time for a Bandwidth Part (BWP). CFRA with 2-step RA type is only supported for handover.

The Msg1 of 4-step RA type includes only a preamble on PRACH, while the MSGA of the 2-step RA type includes a preamble on PRACH and a payload on PUSCH. After Msg1 transmission or MSGA transmission, the UE 102 monitors for a response from the network node 104 within a configured window. For CFRA, upon receiving the network response, the UE 102 ends the random access procedure.

### SUMMARY

It is an object of the present disclosure to provide network devices, terminal devices and methods therein, enabling co-existence of at least two types of RACH procedures and enable resource sharing between at least two types of RACH procedures. The two types of RACH procedures may be for example, a random access procedure in a Non-Terrestrial Network (NTN) and the second random access procedure is a random access procedure in a Terrestrial Network (TN).

According to a first aspect of the present disclosure, a method in a network device is provided. The method may include: determining a Random Access Channel (RACH) configuration according to at least one random access procedure, wherein the RACH configuration comprises a preamble mapping indication indicating mapping of RACH preambles to Synchronization Signal/Physical Broadcast Channels (SSBs) and a SSB mapping indication indicating mapping of SSBs to RACH Occasions (ROs); transmitting the RACH configuration; and receiving a RACH preamble which is transmitted according to the RACH configuration from a terminal device.

In an embodiment, the at least one random access procedure comprises at least two random access procedures, and at least one of the preamble mapping indication and the SSB mapping indication is configured separately for the at least two random access procedures.

In an embodiment, the at least one random access procedure comprise at least one first type of random access procedure in a Non-Terrestrial Network (NTN).

In an embodiment, the at least one first type of random access procedure comprises a normal random access procedure and/or a NTN-specific random access procedure.

In an embodiment, the normal random access procedure is a random access procedure with pre-compensation of Time-Advanced (TA) and/or frequency, and the NTN-specific random access procedure is a random access procedure without the pre-compensation.

In an embodiment, the at least one random access procedure further comprise at least one second type of random access procedure in a Terrestrial Network (TN).

In an embodiment, the at least one second type of random access procedure comprises a 4-step random access procedure and/or a 2-step random access procedure.

In an embodiment, the preamble mapping indication is configured in a way that a sum of the number of preambles configured for the at least two random access procedures for one RO is no more than a total number of preambles for the one RO.

In an embodiment, the SSB mapping indication is configured in a way that ROs mapped in the SSB mapping indication configured for the specific random access procedure are a subset of ROs mapped in the SSB mapping indication configured for the normal random access procedure.

In an embodiment, the method further includes: determining the RO used by the terminal device in transmitting the RACH preamble according to the received RACH preamble, and determining a SSB to which the determined RO is mapped according the SSB mapping indication.

In an embodiment, if a plurality of ROs is determined according to the received RACH preamble, one or more of the plurality of ROs are used in determining the SSB.

In an embodiment, the one or more of the plurality of ROs is the first one of the plurality of ROs.

In an embodiment, the RACH preamble comprises one or more preambles from the terminal device.

According to a second aspect of the present disclosure, a network device is provided. The terminal device may include a transceiver, a processor and a memory. The memory contains instructions executable by the processor whereby the network device is operative to perform the method according to the above first aspect.

According to a third aspect of the present disclosure, a computer readable storage medium is provided. The computer readable storage medium has computer program instructions stored thereon. The computer program instructions, when executed by a processor in a network device, cause the network device to perform the method according to the above first aspect.

According to a fourth aspect of the present disclosure, a method in a terminal device is provided. The method may include: obtaining a Random Access Channel (RACH) configuration from a network device, wherein the RACH configuration is determined according to at least one random access procedure, and comprises a preamble mapping indication indicating mapping of RACH preambles to Synchronization Signal/Physical Broadcast Channels (SSBs) and a SSB mapping indication indicating the mapping of SSBs to RACH Occasions (ROs); selecting a RACH preamble and a RO according to the RACH configuration; and transmitting the RACH preamble on the RO to the network device.

In an embodiment, the at least one random access procedure comprises at least two random access procedure, and wherein at least one of the preamble mapping indication and the SSB mapping indication is configured separately for the at least two random access procedures.

In an embodiment, the at least one random access procedure comprise at least one first type of random access procedure in a Non-Terrestrial Network (NTN).

In an embodiment, the at least one first type of random access procedure comprises a normal random access procedure and/or a NTN-specific random access procedure.

In an embodiment, the normal random access procedure is a random access procedure with pre-compensation of Time-Advanced (TA) and/or frequency, and the NTN-specific random access procedure is a random access procedure without the pre-compensation.

In an embodiment, the at least one random access procedure further comprise at least one second type of random access procedure in a Terrestrial network.

In an embodiment, the at least one second type of random access procedure comprises a 4-step random access procedure and/or a 2-step random access procedure.

In an embodiment, selecting a RACH preamble and a RO according to the RACH configuration includes: determining a SSB according to the received RACH configuration; and determining a RO according to the SSB mapping indication in the received RACH configuration. The transmitting the RACH preamble on the RO to the network device includes transmitting the RACH preamble on the RO and one or more ROs following the RO.

In an embodiment, the RACH preamble comprises one or more preambles.

According to a fifth aspect of the present disclosure, a terminal device is provided. The terminal device may include a transceiver, a processor and a memory. The memory contains instructions executable by the processor whereby the terminal device is operative to perform the method according to the above fourth aspect.

According to a sixth aspect of the present disclosure, a computer readable storage medium is provided. The computer readable storage medium has computer program instructions stored thereon. The computer program instructions, when executed by a processor in a terminal device, cause the terminal device to perform the method according to the above fourth aspect.

With the embodiments of the present disclosure, the SSBs to ROs mapping or the preambles to SSBs mapping are separately configured for two random access procedures, e.g., random access procedure in a NTN and random access procedure in a TN, so that if the network device includes in the RACH configuration two types of mapping that are configured for the two random access procedures respectively, the terminal device that receives the RACH configuration can take resources for random access according to the RACH configuration. Accordingly, coexistence of two random access procedures is enabled in a network.

With the embodiments of the present disclosure, the SSBs to ROs mapping or the preambles to SSBs mapping are separately configured for two random access procedures, so that resource sharing between two types of random access procedures is enabled.

### BRIEF DESCRIPTION OF THE DRAWINGS

The above and other objects, features and advantages will be more apparent from the following description of embodiments with reference to the figures, in which:

FIG. 1 shows an illustrative architecture of a satellite network with bent pipe transponders.

FIG. 2A shows a signaling sequence of a 4-step contention based random access procedure.

FIG. 2B shows a signaling sequence of a 2-step contention based random access procedure.

FIG. 3A illustrates a 4-step random access type contention free random access.

FIG. 3B illustrates a 2-step random access type contention free random access.

FIG. 4 illustrates an example of the RACH Occasion configuration in NR.

FIG. 5 illustrates an example where there is one SSB per RACH occasion.

FIG. 6 illustrates an example where there are 2 SSBs per RACH occasion.

FIG. 7 illustrates an example of the mapping between SSB and RACH preambles.

FIG. 8 illustrates an example of the associated preambles for CBRA and CFRA per SSB per RACH occasion.

FIG. 9 illustrates of the associated preambles for CBRA and CFRA per SSB per PRACH occasion, when Random Access Preambles group B is configured.

FIG. 10 illustrates the associated preambles for CBRA and CFRA per SSB per PRACH occasion, when random access channel occasions (ROs) for 2-step RACH and 4-step RACH are shared.

FIG. 11 illustrates the time and frequency offset ambiguities of ZC sequences, where FIG. 11(a) illustrates the case of ZC with root 56, and FIG. 11(b) illustrates the case of ZC with root of 714.

FIG. 12 illustrates a PRACH format with 2 ZC sequences, where the second ZC sequence is the complex conjugate of the first ZC sequence.

FIG. 13 is a flowchart illustrating a method in a network device according to an embodiment of the present disclosure.

FIG. 14 is a flowchart illustrating a method in a terminal device according to an embodiment of the present disclosure.

FIG. 15 is a block diagram of a network device according to another embodiment of the present disclosure.

FIG. 16 is a block diagram of a network device according to another embodiment of the present disclosure.

FIG. 17 is a block diagram of a terminal device according to an embodiment of the present disclosure.

FIG. 18 is a block diagram of a terminal device according to another embodiment of the present disclosure.

FIG. 19 schematically illustrates a telecommunication network connected via an intermediate network to a host computer.

FIG. 20 is a generalized block diagram of a host computer communicating via a base station with a user equipment over a partially wireless connection.

FIGS. 21 to 24 are flowcharts illustrating methods implemented in a communication system including a host computer, a base station and a user equipment.

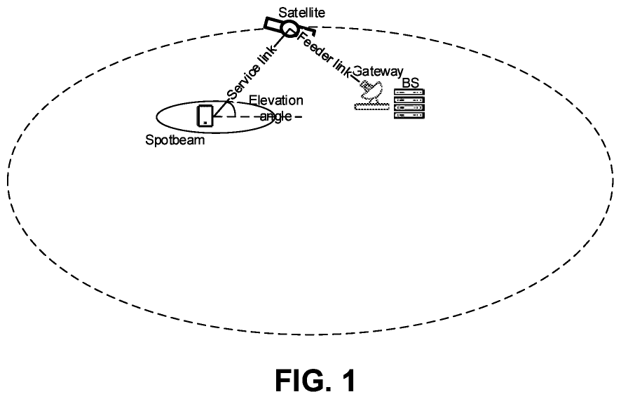

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or gNB, a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network device may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from a network device to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

2.1 NR Rel-15 PRACH Configuration

In NR, the time and frequency resource on which a RACH preamble is transmitted is defined as an RACH Occasion.

The time resources and the preamble format for a RACH preamble is configured by an RACH configuration index. For details of the RACH configuration index, reference can be made to the 3^{rd} Generation Partnership Project (3GPP) Technical Specification (TS) 38.211, which is incorporated herein by reference in its entirety. The RACH configuration index indicates a row in a RACH configuration table specified in TS 38.21, Tables 6.3.3.2-2, 6.3.3.2-3, 6.3.3.2-4 for FR1 (for example, 450 MHz-6 GHz) paired spectrum, FR1 unpaired spectrum and FR2 (for example, 24.25 GHz -52.6 GHz) with unpaired spectrum, respectively, A row in a RACH configuration table specifies the time-domain RACH occasion pattern for one RACH configuration period. One RACH configuration period may be 10, 20, 40, 80, or 160 ms.

Part of the Table 6.3.3.2-3 for FR1 unpaired spectrum for the RACH preamble format 0 is copied in Table 1 below, where the value of x indicates the RACH configuration period in number of system frames. The value of y indicates the system frame within each RACH configuration period on which the RACH occasions are configured. For instance, if y is set to 0, it means RACH occasions only configured in the first frame of each RACH configuration period. The values in the column “subframe number” define which subframes are configured with RACH occasions. The values in the column “starting symbol” are symbol indexes. Determination of time resources for RACH occasions for FR2 using table 6.3.3.2-4 is similar, except that 60 kHz slots are used instead of subframes.

In case of Time Division Duplex (TDD), semi-statically configured downlink parts and/or actually transmitted SSBs can override and invalidate some time-domain RACH occasions defined in the RACH configuration table. More specifically, RACH occasions in the uplink part are always valid, and a RACH occasion within the downlink part is valid as long as it does not precede or collide with an SSB in the RACH slot and it is at least N symbols after the downlink part and the last symbol of an SSB. N is 0 or 2 depending on the RACH format and the subcarrier spacing.

TABLE 1
RACH configuration for preamble format 0 for FR1 unpaired spectrum

| | | | | | | | Nₜ^{RA, slot}, | |
|---|---|---|---|---|---|---|---|---|
| | | | | | | | number of | |
| | | | | | | Number of | time-domain | |
| | | | | | | PRACH | PRACH | |
| RACH | | | | | | slots | occasions | N_{dur}^{RA}, |
| Configuration | Preamble | n_{SFN} mod x = y | | Subframe | Starting | within a | within a | RACH |
| Index | format | x | y | number | symbol | subframe | PRACH slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | | | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, 7, 9 | 0 | — | — | 0 |

In the frequency domain, NR supports multiple frequency-multiplexed RACH occasions on the same time-domain RACH occasion. This is mainly motivated by the support of analog beam sweeping in NR such that the RACH occasions associated to one SSB are configured at the same time instance but different frequency locations. RACH preambles can only be transmitted in the frequency resources given by the higher-layer parameter msg1-FrequencyStart. The frequency resource for RACH occasions n_{RA}∈{0,1, . . . ,M−1}, where M equals the higher-layer parameter msg1-FDM, is numbered in increasing order within the initial active uplink bandwidth part during initial access, starting from the lowest frequency. Otherwise, n_{RA} is numbered in increasing order within the active uplink bandwidth part, starting from the lowest frequency. The number M of RACH occasions that are frequency division multiplexed (FDMed) in one time-domain RACH occasion, can be 1, 2, 4, or 8.

Here the msg1-FDM and msg1-FrequencyStart are defined in “RACH-ConfigGenetic” information element in 3GPP TS 38.211 as below:
msg1-FDM
The number of RACH occasions frequency division multiplexed in one time instance. (see TS 38.211, clause 6.3.3.2)
msg1-FrequencyStart
Offset of a lowest RACH transmission occasion in frequency domain with respective to PRB 0. The value is configured so that the corresponding RACH resource is entirely within the bandwidth of the uplink Bandwidth Part (BWP). (see TS 38.211, clause 6.3.3.2).

The RACH-ConfigGeneric information element is as below:

RACH-ConfigGeneric information element

-- ASNISTART
-- TAG-RACH-CONFIG-GENERIC-START

| | |
|---|---|
| RACH-ConfigGeneric ::= | SEQUENCE { |

| | |
|---|---|
| prach-ConfigurationIndex | INTEGER (0..255), |

| | |
|---|---|
| msg1-FDM | ENUMERATED {one, two, four, eight}, |

| | |
|---|---|
| msg1-FrequencyStart | INTEGER (0..maxNrofPhysicalResourceBlocks−1), |

| | |
|---|---|
| zeroCorrelationZoneConfig | INTEGER(0..15), |
| preambleReceivedTargetPower | INTEGER (−202..−60), |

| | |
|---|---|
| preambleTransMax | ENUMERATED {n3, n4, n5, n6, n7, n8, n10, n20, n50, n100, |

n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

...
}
-- TAG-RACH-CONFIG-GENERIC-STOP
-- ASN1STOP

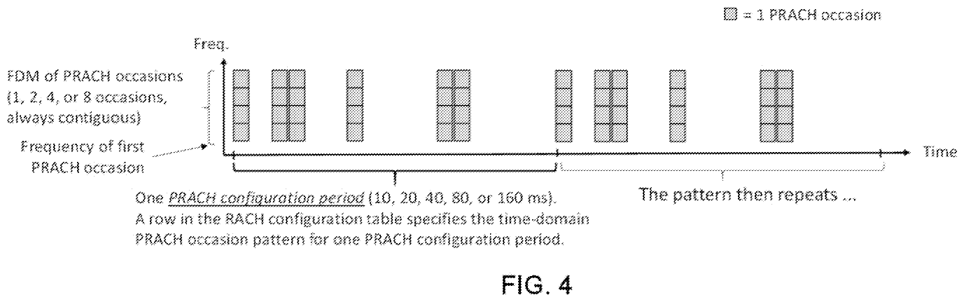

FIG. 4 illustrates an example of the RACH Occasion configuration in NR. As shown in FIG. 4, four RACH occasions are frequency division multiplexed in one time instance.

In NR Rel-15, there are up to 64 sequences that can be used as RACH preambles per RACH occasion in each cell. The RRC parameter totalNumberOfRA-Preambles determines how many of these 64 sequences are used as RACH preambles per RACH occasion in each cell. The 64 sequences are configured by including firstly all the available cyclic shifts of a root Zadoff-Chu sequence, and secondly in the order of increasing root index, until 64 preambles have been generated for the RACH occasion.

2.2 NR Rel-15 Association Between SSB and PRACH Occasion

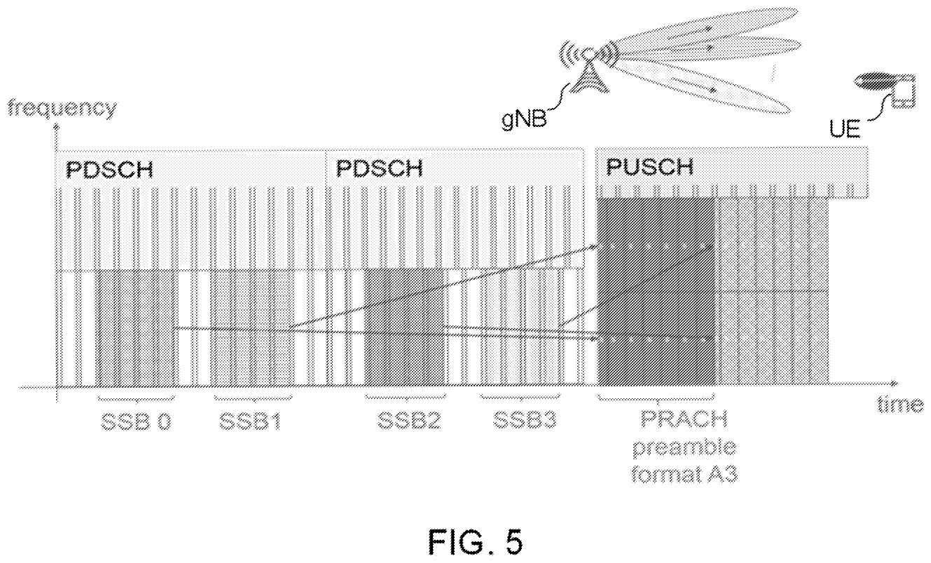

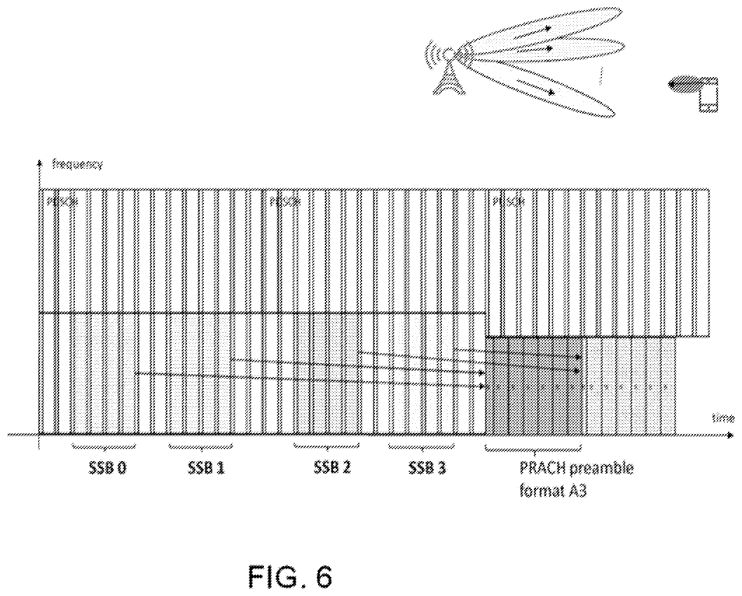

NR Rel-15 supports one-to-one, one-to-many, and many-to-one association between SSB and RACH Occasions, as illustrated in FIG. 5 and FIG. 6, where FIG. 5 illustrates an example where there is one SSB per RACH occasion, and FIG. 6 illustrates an example where there are 2 SSBs per RACH occasion.

The RACH preambles associated to each SSB is configured by two RRC parameters in RACH-ConfigCommon:

ssb-perRACH-OccasionAndCB-PreamblesPerSSB and totalNumberOfRA-Preambles.

The detailed mapping rule is specified in TS 38.213 section 8.1 (which is incorporated herein by reference in its entirety), as following:
For Type-1 random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB.
A UE is provided a number N of SS/PBCH blocks associated with one PRACH occasion and a number R of contention-based preambles per SS/PBCH block per valid PRACH occasion by ssb-perRACH-OccasionAndCB-PreamblesPerSSB. If N<1, one SS/PBCH block is mapped to 1/N consecutive valid PRACH occasions and R contention based preambles with consecutive indexes associated with the SS/PBCH block per valid PRACH occasion start from preamble index 0. If N≥1, R contention based preambles with consecutive indexes associated with SS/PBCH block n, 0≤n≤N−1, per valid PRACH occasion start from preamble index n·N_{preamble}^{total}/N where N_{preamble}^{total} is provided by totalNumberOfRA-Preambles and is an integer multiple of N.
SS/PBCH block indexes provided by ssb-PositionsInBurst in SIB1 or in ServingCellConfigCommon are mapped to valid PRACH occasions in the following order where the parameters are described in [4, TS 38.211].
First, in increasing order of preamble indexes within a single PRACH occasion
Second, in increasing order of frequency resource indexes for frequency multiplexed PRACH occasions
Third, in increasing order of time resource indexes for time multiplexed PRACH occasions within a PRACH slot
Fourth, in increasing order of indexes for PRACH slots

An association period, starting from frame 0, for mapping SS/PBCH blocks to PRACH occasions is the smallest value in the set determined by the PRACH configuration period according Table 8.1-1 such that N_{Tx}^{SSB} SS/PBCH blocks are mapped at least once to the PRACH occasions within the association period, where a UE obtains N_{Tx}^{SSB} from the value of ssb-PositionsInBurst in SIB1 or in ServingCellConfigCommon. If after an integer number of SS/PBCH blocks to PRACH occasions mapping cycles within the association period there is a set of PRACH occasions that are not mapped to N_{Tx}^{SSB} SS/PBCH blocks, no SS/PBCH blocks are mapped to the set of PRACH occasions. An association pattern period includes one or more association periods and is determined so that a pattern between PRACH occasions and SS/PBCH blocks repeats at most every 160 msec. PRACH occasions not associated with SS/PBCH blocks after an integer number of association periods, if any, are not used for PRACH transmissions.

In other words, the mapping between SSB and preambles in done by consecutively associating M preambles to each SSB, where M=N_{preamble}^{total}/N, and the preambles are taken in the following order
First, in increasing order of preamble indexes within a single PRACH occasion.
Second, in increasing order of frequency resource indexes for frequency multiplexed PRACH occasions.
Third, in increasing order of time

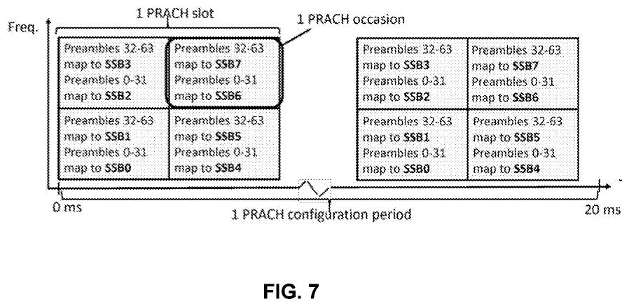

FIG. 7 illustrates an example of the mapping between SSB and RACH preambles, where the number of SSBs is 8, M=32 (i.e., 2 SSB per RACH occasions), the number of RACH occasions that are frequency division multiplexed in one time instance is 2. The RACH format is A3, i.e., 2 TD RACH occasions per slot. The RACH configuration period is 20 ms, and there are 2 RACH slots per configuration period.

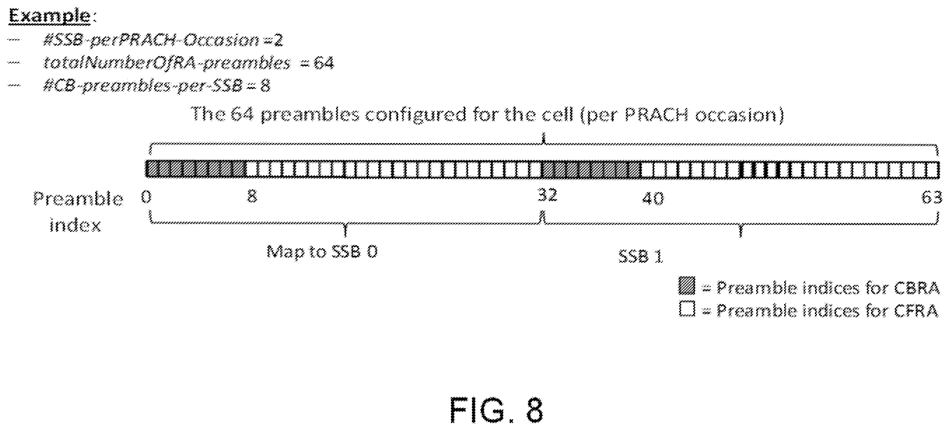

For each SSB, the associated preambles per PRACH occasion, N_{preamble}^{total}/N, are further divided into two sets for Contention Based Random Access (CBRA) and Contention Free Random Access (CFRA). The number of CB preambles per SSB per PRACH occasion, R, is signaled by the RRC parameter ssb-perRACH-OccasionAndCB-PreamblesPerSSB. Preamble indices for CBRA and CFRA are mapped consecutively for one SSB in one PRACH occasion, as shown in FIG. 8. FIG. 8 illustrates an example of the associated preambles for CBRA and CFRA per SSB per RACH occasion.

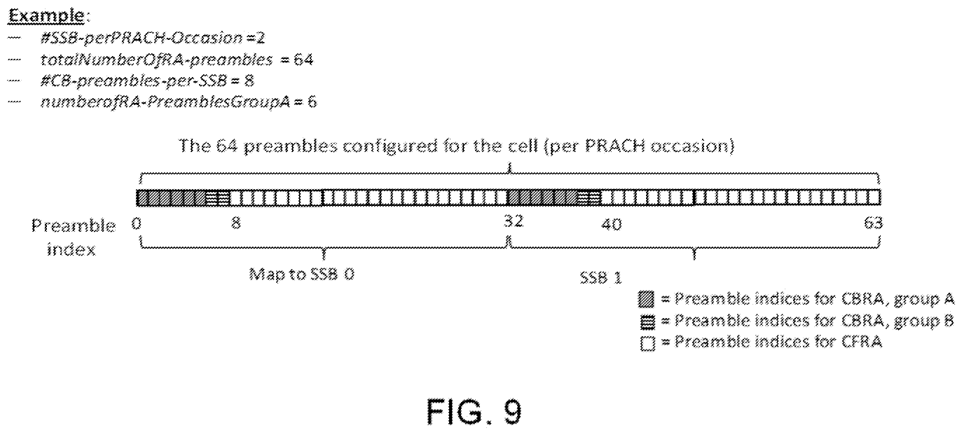

If Random Access Preambles group B is configured for CBRA, then, amongst the CBRA preambles (#CB-preambles-per-SSB) associated with an SSB, the first numberOfRA-PreamblesGroupA Random Access Preambles belong to Random Access Preambles group A, and the remaining Random Access Preambles associated with the SSB belong to Random Access Preambles group B. FIG. 9 illustrates of the associated preambles for CBRA and CFRA per SSB per PRACH occasion, when Random Access Preambles group B is configured.

The RACH-ConfigCommon information element is as below:

RACH-ConfigCommon information element

-- ASN1START
-- TAG-RACH-CONFIGCOMMON-START

| | |
|---|---|
| RACH-ConfigCommon ::= | SEQUENCE { |

| | |
|---|---|
| rach-ConfigGeneric | RACH-ConfigGeneric, |
| totalNumberOfRA-Preambles | INTEGER |

| | |
|---|---|
| (1..63) | OPTIONAL, --Need S |

ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED |

{n4,n8,n12,n16,n20,n24,n28,n32},

| | |
|---|---|
| four | INTEGER (1..16), |
| eight | INTEGER (1..8), |
| sixteen | INTEGER (1..4) |

```
  }
      OPTIONAL, -- Need M
```

| | |
|---|---|
| groupBconfigured | SEQUENCE { |

| | |
|---|---|
| ra-Msg3SizeGroupA | ENUMERATED {b56, b144, b208, b256, b282, b480, |

b640,

b800, b1000, b72, spare6,

spare5,spare4, spare3, spare2, spare1},

| | |
|---|---|
| messagePowerOffsetGroupB | ENUMERATED { minusinfinity, dB0, dB5, dB8, dB10, |

dB12, dB15, dB18},

| | |
|---|---|
| numberOfRA-PreamblesGroupA | INTEGER (1..64) |

}

According to TS 38.213, one of the two conditions must be met in order for a UE to select Random Access Preambles group B for PRACH transmission:

Condition 1: potential Msg3 size (UL data available for transmission plus MAC header and, where required, MAC CEs) is greater than ra-Msg3SizeGroupA and the pathloss is less than PCMAX (of the Serving Cell performing the Random Access Procedure)—preambleReceivedTargetPower—msg3-DeltaPreamble—messagePowerOffsetGroupB; or
Condition 2: the Random Access procedure was initiated for the CCCH logical channel and the CCCH SDU size plus MAC subheader is greater than ra-Msg3SizeGroupA.

2.3 NR Rel-16 for MsqA Configuration

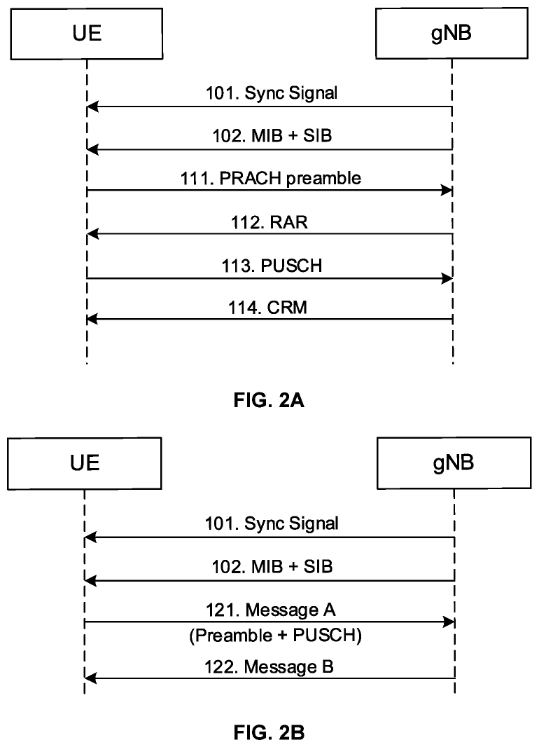

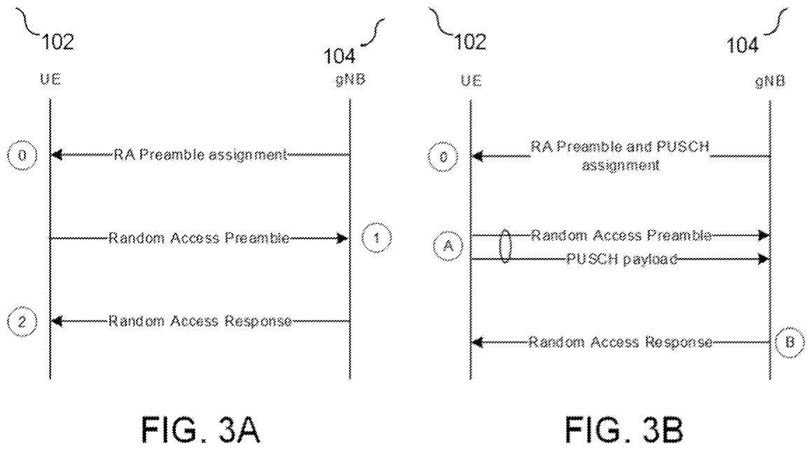

The RACH occasions for 2-step RACH shown in FIG. 2 can be either separately configured (also known as Type-2 random access procedure with separate configuration of PRACH occasions with Type-1 random access procedure) or are shared with 4-step RACH (also known as Type-2 random access procedure with common configuration of PRACH occasions with Type-1 random access procedure) in which case different set of preamble IDs will be used.

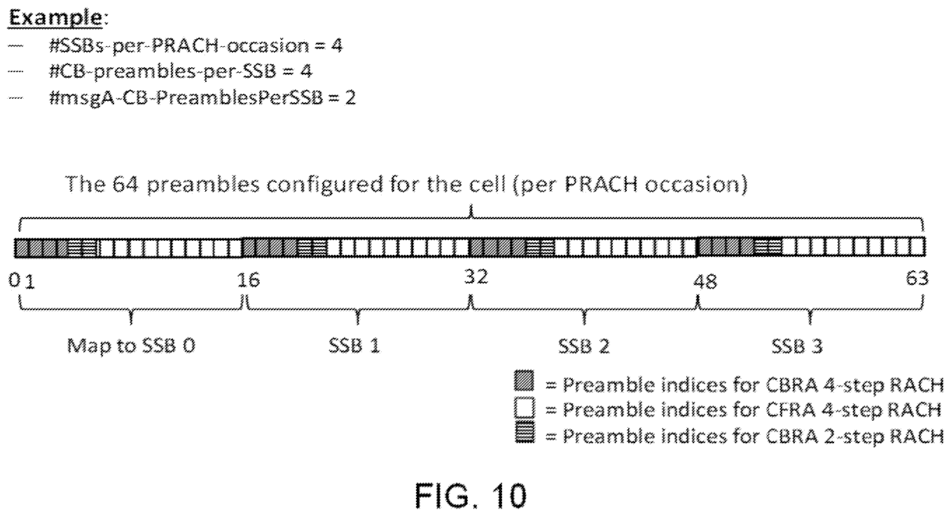

For Type-2 random access procedure with common configuration of PRACH occasions with Type-1 random access procedure, a UE is provided a number N of SS/PBCH blocks associated with one PRACH occasion by ssb-perRACH-OccasionAndCB-PreamblesPerSSB and a number Q of contention based preambles per SS/PBCH block per valid PRACH occasion by msgA-CB-PreamblesPerSSB. The PRACH transmission can be on a subset of PRACH occasions associated with a same SS/PBCH block index for a UE provided with a PRACH mask index by msgA-ssb-sharedRO-MaskIndex. FIG. 10 illustrates the associated preambles for CBRA and CFRA per SSB per PRACH occasion, when random access channel occasions (ROs) for 2-step RACH and 4-step RACH are shared.

For Type-2 random access procedure with separate configuration of PRACH occasions with Type-1 random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB-msgA when provided; otherwise, by ssb-perRACH-OccasionAndCB-PreamblesPerSSB. Because the SSB to RO mapping and the preamble allocation are independently configured, the example provided for 4-step RACH in FIG. 9 is also valid for this case of 2-step RACH except that the parameters are separately configured for 2-step RACH.

2.4 New PRACH Format for NTN

To design a suitable PRACH format for both UL timing estimation and UL frequency estimation, it is imperative to first understand why the existing NR PRACH formats based on ZC sequences cannot meet the target. It is well known that there are several peaks in the ambiguity function of ZC sequences in the Delay-Doppler plane, leading to many timing and Doppler ambiguities. Due to the nature of ZC sequences, both delay and frequency shift cause cyclic shift in the observation window of received ZC sequences at the gNB. As a result, two issues may arise.
It is difficult if not impossible to separate the two effects (delay and frequency shifts) by observing the composite cyclic shift. Separating them in order to estimate delay and/or frequency shift is needed. This issue exists, even if cyclic shifted ZC sequences with the same root are not used.
If cyclic shifted ZC sequences are used, the composite shift may make sequence A become sequence B, leading to misdetection. This issue has resulted in the introduction of restricted sets in PRACH formats.

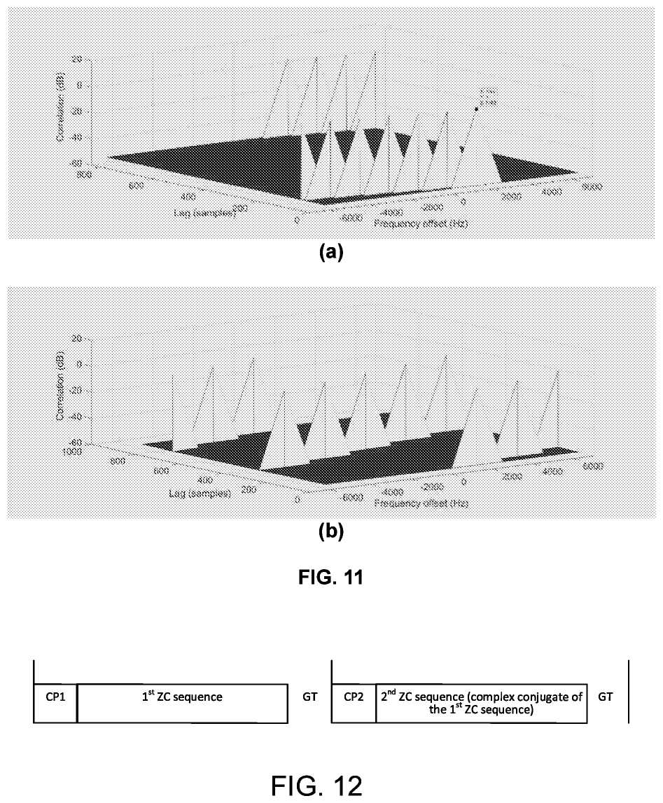

We give a concrete example, illustrating the timing and Doppler ambiguities in PRACH. Assume zero delay and 1.25 kHz frequency offset between transmitter and receiver. The receiver aims to estimate delay and frequency offset by cross correlating the received signal with its reference copy of the transmitted signal. The correlation is performed at multiple hypotheses of frequency offsets that are on the step size of 1.25 kHz. The sampling rate is 30.72 MHz. The cross correlation results are plotted in FIG. 11(a) and FIG. 11(b) for ZC sequences with roots 56 and 714, respectively. The correlation values in FIG. 11(a) and FIG. 11(b) are normalized by the maximum correlation value, yielding a maximum value of 0 dB in each figure. It is clear that in either FIG. 11(a) and FIG. 11(b) multiple correlation peaks of the same height are observed. This implies that it is impossible to separate the effects of delay and frequency offset in PRACH in the presence of both large timing and frequency uncertainties, leading to difficulties in timing estimate at the gNB and misdetection of random access preambles.

We can understand the timing and frequency offset ambiguities of ZC sequences by examining their theoretical properties. To this end, we introduce the following notation.
N_{ZC}: the length of a ZC sequence
u: the root of a ZC sequence, and 0<u<N_{ZC}
p: the inverse modulo N_{ZC} of u, i.e., (p*u) mod N_{ZC}=1, and 0<p<N_{ZC}
f_{SC}: the subcarrier spacing of an OFDM signal
Δf: the frequency offset between transmitted and received signals
n₀: the delay of received signals relative to the transmitted signal

Let′ consider the following form of ZC sequences:

$${x}_{u} [ n ] = exp ( - \frac{j π u n ( n + 1 )}{{N}_{ZC}} ) , n = 0 , 1 , … , {N}_{Z C} - 1 .$$

If N_{ZC} is a prime, each u is associated with a unique inverse modulo N_{ZC}. It can be shown that if k=Δf/f_{SC} (and for simplicity k is assumed to be an integer), the peak of cross correlation of the transmitted and received signals is located at the position of (n₀+kp) mod N_{ZC}. Clearly, both delay and frequency shift cause cyclic shift in the received ZC sequences, resulting in a composite cyclic shift from which the effect of delay cannot be separated from the effect of frequency shift.

The above analysis also sheds light on how to design a PRACH format to resolve the timing and frequency offset ambiguities. Intuitively, two equations can be used to solve for two unknowns (delay and frequency offset). In particular, if a transmitter sends two signals based on two ZC sequences (that have different properties), the receiver can resolve the timing and frequency offset ambiguities by processing the two received signals.

For example, for 2 ZC sequences with roots u and −u respectively, the peak of cross correlation of the transmitted and received signals locate at two positions:
Position 1: s₁=(n₀+kp) mod N_{ZC}
Position 2: s₂=(n₀−kp) mod N_{ZC}

In this case, the second ZC sequence can be treated as the complex conjugate of the first ZC sequence, as shown in FIG. 12, which illustrates a PRACH format with 2 ZC sequences, where the second ZC sequence is the complex conjugate of the first ZC sequence. With two equations, the delay n₀ can be estimated as

$${n}_{0} = \frac{( {s}_{1} + {s}_{2} ) mod {N}_{Z C}}{2}$$

Once the delay is estimated, the frequency offset can then be readily estimated.

Note that for simplicity we assume that the frequency offset is an integer multiple of the subcarrier spacing. For more general case, it can be shown that the squared autocorrelation of ZC sequence is given by “Solutions for NR to support non-terrestrial networks (NTN),” 3GPP RAN #86, RP-193234.

$${\vert γ ( {n}_{0} , Δ f ) \vert}^{2} = {\vert sinc ( \frac{Δ f}{{f}_{SC}} - u {n}_{0} ) \vert}^{2} .$$

Here the sinc function is defined as

$$sinc ( x ) = \frac{1}{N} \frac{sin ( π x )}{sin ( πx / N )} .$$

Then by processing the two received ZC sequences with roots u and −u respectively, we could estimate the delay n₀ and the frequency offset Δf accordingly.

FIG. 12 illustrates a PRACH format with 2 AC sequences, where the second ZC sequence is the complex conjugate of the first AC sequence.

Note that the PRACH format illustrated in FIG. 12 has minimal specification impact. The transmission of the first ZC sequence follows an existing NR PRACH format, and the change would be merely to request one additional transmission of a second ZC sequence that is the complex conjugate of the first ZC sequence.

Normal PRACH design can be used in NTN when pre-compensation of large Time-Advanced (TA) and large frequency error is assumed to be reliable. But separate NTN-specific PRACH design may also be needed for NTN when large TA and large Doppler shift exist without pre-compensation during the PRACH transmission. Furthermore, TN and NTN may also coexist so that radio resources can be more efficiently used.

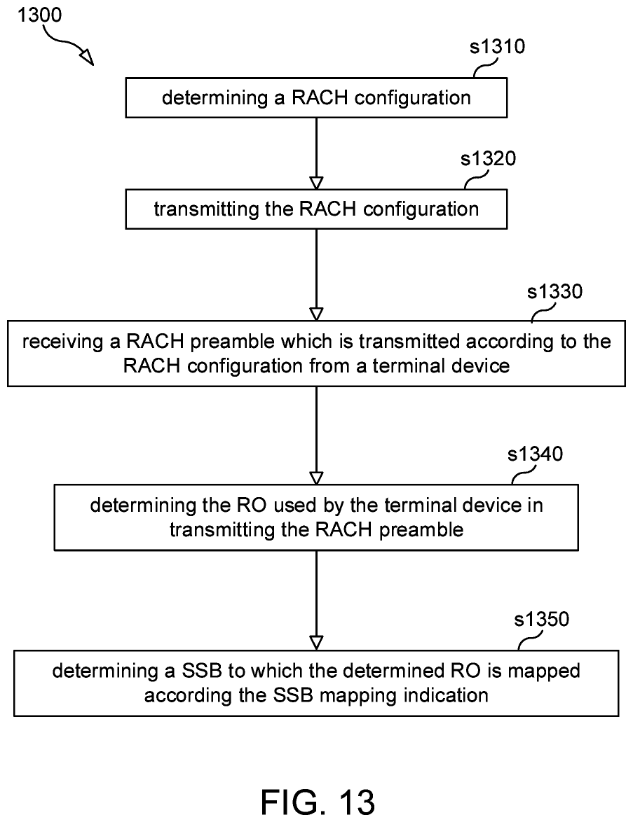

FIG. 13 is a flowchart illustrating a method 1500 according to an embodiment of the present disclosure. The method 1500 can be performed at a network device, e.g., a gNB.

At step s1510, the network device determines a Random Access Channel (RACH) configuration according to at least one random access procedure. The RACH configuration comprises a preamble mapping indication indicating mapping of RACH preambles to Synchronization Signal/Physical Broadcast Channels (SSBs) and a SSB mapping indication indicating mapping of SSBs to RACH Occasions (ROs). The RACH configuration is to assign resources for transmitting PRACH preambles.

At step s1520, the network device transmits the RACH configuration. For CBRA, the network device broadcasts the RACH configuration in its serving cell.

Then at step s1530, the network device receives a RACH preamble which is transmitted according to the RACH configuration from a terminal device. A terminal device in the cell may obtain the broadcasted RACH configuration, and transmit a RACH preamble to the network device according to the RACH configuration for random access.

In an embodiment, the at least one random access procedure comprises at least two random access procedures, and wherein at least one of the preamble mapping indication and the SSB mapping indication is configured separately for the at least two random access procedures.

In an embodiment, the at least one random access procedure comprise at least one first type of random access procedure in a Non-Terrestrial Network (NTN).

For example, the at least one first type of random access procedure comprises a normal random access procedure and/or a NTN-specific random access procedure. In an embodiment, the normal random access procedure is a random access procedure with pre-compensation of Time-Advanced (TA) and/or frequency, and the NTN-specific random access procedure is a random access procedure without the pre-compensation.

The term “NTN-specific random access procedure” is used herein for a random access procedure with a NTN-specific PRACH design in NTN, especially a random access procedure when the pre-compensation of large TA and/or doppler shift cannot be compensated or can be compensated but not reliable for the transmission of PRACH on the transmitter side, which may happen, e.g., when the GNSS function cannot work or when there's no GNSS capability or when the accuracy of the timing frequency error estimation is not accurate enough based on GNSS. In this RA procedure type, the PRACH transmission is called “NTN-specific PRACH transmission” in this disclosure.

Relative to “NTN-specific random access procedure”, another term “normal random access procedure” is used in this disclosure for the random access procedure in NTN when the PRACH transmission design for a terrestrial network till NR R16 is reused, where the PRACH transmission is called “normal PRACH transmission” in this disclosure.

In an embodiment, the at least one random access procedure comprises at least two random access procedures, and wherein the preamble mapping indication is configured separately for the at least two random access procedures.

For example, for the resources assignment for normal random access procedure and NTN-specific random access procedure in a NTN, if the ROs defined for normal PRACH transmission are shared with NTN-specific PRACH transmission, the SSB to RO mapping for normal PRACH transmission is reused. The number of preambles per SSB can be separately configured considering different preambles should be used by the two random access procedures.

As an example, a separate parameter PreamblesPerSSB-NTN is introduced for indication of the number of preambles per SSB for NTN-specific random access procedure, while the number of SSBs per RO can be determined by the first part of the existing parameter ssb-perRACH-OccasionAndCB-PreamblesPerSSB. The RACH-ConfigCommon information element for the NTN-specific random access procedure may be as below:

| | |
|---|---|
| RACH-ConfigCommon ::= | SEQUENCE { |

| | |
|---|---|
| rach-ConfigGeneric | RACH-ConfigGeneric, |

| | |
|---|---|
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

```
      }
  PreamblesPerSSB-NTN CHOICE {
```

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
...
}

In an embodiment, the at least one random access procedure comprises at least two random access procedures, and the SSB mapping indication is configured separately for the at least two random access procedures.

In an embodiment, even if the ROs defined for normal PRACH transmission are shared with NTN-specific PRACH transmission, the SSB to RO mapping can be separately configured, since each PRACH transmission in NTN-specific random access procedure can be independent from the PRACH transmission in normal random access procedure in NTN.

As an example, a parameter ssb-perRACH-OccasionAndCB-PreamblesPerSSB-NTN can be included in the RACH-ConfigCommon IE to determine the number of SSBs mapped to each RO and the number of preambles per SSB for the NTN-specific random access procedure. The RACH-ConfigCommon information element for the NTN-specific random access procedure may be as below:

| | |
|---|---|
| RACH-ConfigCommon ::= | SEQUENCE { |

| | |
|---|---|
| rach-ConfigGeneric | RACH-ConfigGeneric, |

| | |
|---|---|
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

```
      }
  ssb-perRACH-OccasionAndCB-PreamblesPerSSB-NTN CHOICE {
```

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
...
}

In an embodiment, the SSB mapping indication is configured in a way that ROs mapped in the SSB mapping indication configured for the NTN-specific random access procedure are a subset of ROs mapped in the SSB mapping indication configured for the normal random access procedure.

In the embodiment, only a subset of the ROs defined for normal random access procedure are used by NTN-specific random access procedure, and thus the SSB to RO mapping can be separately configured so that only the subset of ROs that are used by NTN-specific random access procedure is considered in the SSB to RO mapping.

An advantage of the embodiment is to reduce the density of ROs for normal random access procedure in time domain to avoid PRACH receiving windowing overlapping due to the large propagation delay difference between terminal devices in NTN-specific random access procedure, especially when the pre-compensation of time error is not applied or not reliable during the PRACH transmission which is the main use case for NTN-specific random access procedure.

In an embodiment, the method 1500 may further comprise step s1540 of determining the RO used by the terminal device in transmitting the RACH preamble according to the received RACH preamble, and step s1550 of determining a SSB to which the determined RO is mapped according the SSB mapping indication. Steps s1540 and s1550 are to determine the SSB for subsequence transmission for the terminal device.

In an embodiment, the terminal device may transmit a RACH preamble on more than one RO, or transmit more than one RACH preamble on more than one RO. The RACH preamble received by the network device comprises one or more preambles from the terminal device. For example, the terminal device may transmit a first RACH preamble and a second RACH preamble which is a complex conjugate of the first RACH preamble in a NTN-specific random access procedure. The terminal device determines the SSB with the best measurement, determines the RO according to the SSB mapping indication, and then transmits the one or more RACH preamble on the RO and one or more ROs following the RO. In the embodiment, the network device may determine a plurality of ROs according to the received RACH preamble in step s1540. The network device uses one or more of the plurality of ROs in determining the SSB in step s1550. In an embodiment, the first RO of the plurality of ROs is used in determining the SSB in step s1550.

In an example, when multiple ROs for normal random access procedure are used for single NTN-specific PRACH transmission, only one of the multiple ROs are counted for SSB to RO mapping and the remaining one or more ROs used for this single NTN-specific PRACH transmission are mapped to same SSB as the one counted for SSB to RO mapping for NTN-specific random access procedure.

As an example, if 2 normal ROs are used for an NTN-specific PRACH transmission with double PRACH sequence (each sequence is transmitted in each one of the ROs), only the 1st RO is counted for SSB to RO mapping and the 2nd RO is assumed to have same SSBs mapped as the 1st RO.

In another embodiment, when the normal random access procedure and NTN-specific random access procedure does not coexist in one cell in the NTN, the signaling for SSB to RO mapping for normal random access procedure is reused for NTN, but a separate IE can be introduced for NTN-specific random access procedure. E.g., RACH-ConfigCommonNTN can be used for NTN-specific random access procedure similar to RACH-ConfigCommon for normal random access procedure. The RACH-ConfigCommon information element for the NTN-specific random access procedure when the normal random access procedure and NTN-specific random access procedure does not coexist in one cell in the NTN may be as below:

| | |
|---|---|
| RACH-ConfigCommonNTN ::= | SEQUENCE { |
| rach-ConfigGeneric | RACH-ConfigGeneric, |

| | |
|---|---|
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
...
}

In an embodiment, the at least one random access procedure further comprise at least one second type of random access procedure in a Terrestrial Network (TN). That is, the TN and the NTN coexist in one cell. The at least one random access procedure may be at least one random access procedure in NTN and at least one random access procedure in TN.

In an embodiment, the at least one second type of random access procedure comprises a 4-step random access procedure and/or a 2-step random access procedure in TN.

In an embodiment, the preamble mapping indication is configured separately for the at least one random access procedure in NTN and the at least one random access procedure in TN.

In an embodiment, the ROs are shared between TN and NTN, the SSB to RO mapping for NTN is reused from TN and the number of preambles per SSB is separately configured.

As an example, CB-PreamblesPerSSB-NTN is separately configured to indicate the number of preambles per SSB for NTN on top of the number of preambles per SSB for TN indicated by the 2nd part of ssb-perRACH-OccasionAndCB-PreamblesPerSSB. The RACH-ConfigCommon information element for the NTN random access procedure may be as below:

| | |
|---|---|
| RACH-ConfigCommon ::= | SEQUENCE { |

| | |
|---|---|
| rach-ConfigGeneric | RACH-ConfigGeneric, |

| | |
|---|---|
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

```
      }
  CB-PreamblesPerSSB-NTN INTEGER {1..64}
}
...
}
```

In an embodiment, the preamble mapping indication is configured in a way that a sum of the number of preambles configured for the at least two random access procedures for one RO is no more than a total number of preambles for the one RO.

For example, the number preambles per SSB for NTN X₂ multiplied by the number of SSBs per PRACH occasion for TN Y1 should be no more than the total number of preambles for the PRACH occasion Tₐₗₗ subtracted by the number of preambles in the PRACH occasion for TN T_{TN}, i.e., X₂*Y₁≤Tₐₗₗ−T_{TN}. T_{TN}=X1*Y₁ where X₁ is the number of preambles per SSB for TN.

In the embodiment, only a part of the ROs defined for TN are used by NTN network, and the SSB to RO mapping can be separately configured so that only the subset of ROs that are used by NTN RA is considered in the SSB to RO mapping.

An advantage of the embodiment is to reduce the density of ROs for TN in time domain to avoid PRACH receiving windowing overlapping due to the large propagation delay difference between terminal devices in NTN, especially when the pre-compensation of time error is not applied or not reliable during the PRACH transmission.

For example, ssb-perRACH-OccasionAndCB-PreamblesPerSSB can be assumed to be the parameter of indication of SSB to RO mapping for TN, and a parameter ssb-perRACH-OccasionAndCB-PreamblesPerSSB-NTN additionally introduced can be the parameter of indication of the SSB to RO mapping for NTN. The RACH-ConfigCommon information element for this case may be as below:

| | |
|---|---|
| RACH-ConfigCommon ::= | SEQUENCE { |

| | |
|---|---|
| rach-ConfigGeneric | RACH-ConfigGeneric, |

| | |
|---|---|
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

```
      }
  ssb-perRACH-OccasionAndCB-PreamblesPerSSB-NTN CHOICE {
```

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
...
}

In another embodiment, when the TN and NTN coexist in one cell, separate set of ROs are configured for NTN, and separate SSB to RO mapping for TN and NTN are needed. The RACH-ConfigCommon information element for this case may be as below:

| | |
|---|---|
| RACH-ConfigCommon ::= | SEQUENCE { |

| | |
|---|---|
| rach-ConfigGeneric | RACH-ConfigGeneric, |

| | |
|---|---|
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

```
      }
  ssb-perRACH-OccasionAndCB-PreamblesPerSSB-NTN CHOICE {
```

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
...
}

In another embodiment, when multiple PRACH occasions for TN are used for single NTN PRACH transmission, only one of the multiple PRACH occasions (e.g., the first RO) are counted for SSB to RO mapping and the remaining one or more PRACH occasions used for this single PRACH transmission in NTN are mapped to same SSBs as the one counted for SSB to RO mapping for RA in NTN.

As an example, if 2 normal ROs are used for the transmission of a PRACH transmission with double PRACH sequence (each sequence is transmitted in each one of the ROs) in NTN, only the 1^{st} RO is counted for SSB to RO mapping and the 2^{nd} RO is assumed to have same SSBs mapped as the 1^{st} RO.

In another embodiment, when the TN and NTN does not coexist in one cell, the signaling for SSB to RO mapping for normal random access procedure is reused for a NTN random access procedure, but a separate IE can be introduced. E.g., RACH-ConfigCommonNTN can be used for NTN similar to RACH-ConfigCommon for TN. The RACH-ConfigCommon information element for this case may be as below:

| | |
|---|---|
| RACH-ConfigCommonNTN ::= | SEQUENCE { |
| rach-ConfigGeneric | RACH-ConfigGeneric, |

| | |
|---|---|
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |

}
...
}

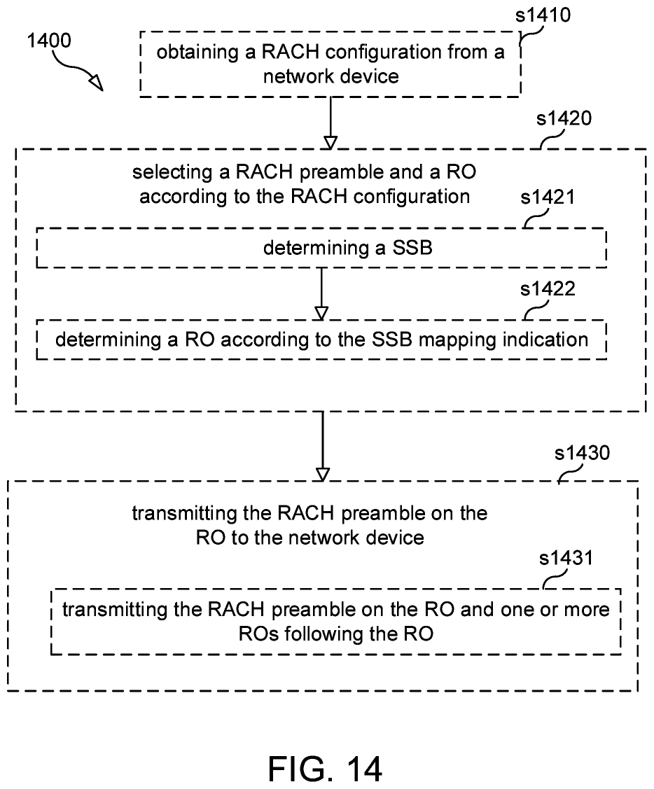

FIG. 14 is a flowchart illustrating a method 1400 according to an embodiment of the present disclosure. The method 1400 can be performed in a terminal device, e.g., a UE.

At step s1410, the terminal device obtains a RACH configuration from a network device. The RACH configuration is determined according to at least one random access procedure, and comprises a preamble mapping indication indicating mapping of RACH preambles to SSBs and a SSB mapping indication indicating the mapping of SSBs to ROs. The terminal device then selects a RACH preamble and a RO according to the RACH configuration at step s1420, and transmits the RACH preamble on the RO to the network device at step s1430.

In an embodiment, the at least one random access procedure comprises at least two random access procedures, and at least one of the preamble mapping indication and the SSB mapping indication is configured separately for the at least two random access procedures.

In an embodiment, the at least one random access procedure comprise at least one first type of random access procedure in a Non-Terrestrial Network (NTN).

For example, the at least one first type of random access procedure comprises a normal random access procedure and/or a NTN-specific random access procedure. In an embodiment, the normal random access procedure is a random access procedure with pre-compensation of Time-Advanced (TA) and/or frequency, and the NTN-specific random access procedure is a random access procedure without the pre-compensation.

In an embodiment, the at least one random access procedure comprises at least two random access procedures, and the preamble mapping indication is configured separately for the at least two random access procedures.

In an embodiment, the at least one random access procedure further comprise at least one second type of random access procedure in a Terrestrial Network (TN). That is, the TN and the NTN coexist in one cell. The at least one random access procedure may be at least one random access procedure in NTN and at least one random access procedure in TN.

In an embodiment, the at least one second type of random access procedure comprises a 4-step random access procedure and/or a 2-step random access procedure in TN.

In an embodiment, step s1420 of selecting a RACH preamble and a RO according to the RACH configuration may comprises step s1421 of determining a SSB according to the received RACH configuration, and step s1422 of determining a RO according to the SSB mapping indication in the received RACH configuration. In an embodiment, the terminal device may transmit a RACH preamble on more than one RO, or transmit more than one RACH preamble on more than one RO. For example, the terminal device may transmit a first RACH preamble and a second RACH preamble which is a complex conjugate of the first RACH preamble in a NTN-specific random access procedure. In the embodiment, step s1430 of transmitting the RACH preamble on the RO to the network device may comprise step s1431 of transmitting the RACH preamble on the RO and one or more ROs following the RO.

In some of the methods, the random access procedure is determined by a UE, which is based on at least one of the following factors:

The measurement on downlink signals and channels by the UE, e.g. when SS-RSRP and/or SS-RSRQ is lower than a predetermined or signaled value, a normal random access procedure in NTN is selected when both normal and NTN-specific RA procedures are configured;

The service type, e.g. a normal random access procedure is selected for UEs in a time-critical operation, a NTN-specific random access procedure is selected for UEs in non-time critical operation;

The time offset and/or the frequency offset estimated for pre-compensation, e.g. a normal random access procedure can be selected by UEs when the time offset and/or the frequency offset estimated is less than a threshold; otherwise, NTN-specific random access procedure is always used;

The number of times failed in one type of random access procedure, e.g. when a UE failed to access the network N times based on normal random access procedure, it can select a NTN-specific random access procedure. Here the number of trials can be a predetermined value or signaled from base station via e.g. broadcasting messages.

The SSB selected, e.g. when a wider beam SSB is selected, an NTN-specific random access procedure can be applied.

The UE speed, e.g. when UE is stationary, a normal random access procedure can be selected.

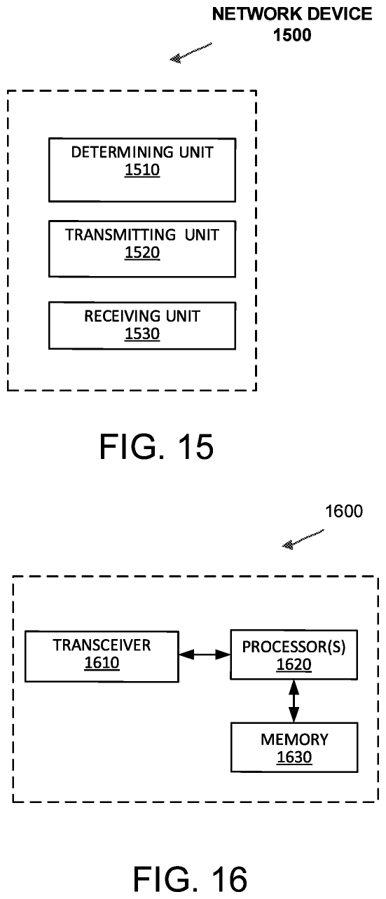

Correspondingly to the method 1300 as described above, a network device is provided. FIG. 15 is a block diagram of a network device 1500 according to an embodiment of the present disclosure.

As shown in FIG. 15, the network device 1500 includes a determining unit 1510 configured to determine a RACH configuration according to at least one random access procedure. The RACH configuration comprises a preamble mapping indication indicating mapping of RACH preambles to SSBs and a SSB mapping indication indicating mapping of SSBs to ROs. The RACH configuration is to assign resources for transmitting PRACH preambles.

The network device 1500 further include a transmitting unit 1520 configured to transmit the RACH configuration. For CBRA, the network device broadcasts the RACH configuration in its serving cell.

The network device 1500 may further include a receiving unit 1530 configured to receive a RACH preamble which is transmitted according to the RACH configuration from a terminal device. A terminal device in the cell may obtain the broadcasted RACH configuration, and transmit a RACH preamble to the network device according to the RACH configuration for random access.

In an embodiment, the at least one random access procedure comprises at least two random access procedures, and at least one of the preamble mapping indication and the SSB mapping indication is configured separately for the at least two random access procedures.

In an embodiment, the at least one random access procedure comprise at least one first type of random access procedure in a NTN.

For example, the at least one first type of random access procedure comprises a normal random access procedure and/or a NTN-specific random access procedure. In an embodiment, the normal random access procedure is a random access procedure with pre-compensation of TA and/or frequency, and the NTN-specific random access procedure is a random access procedure without the pre-compensation.

In an embodiment, the at least one random access procedure comprises at least two random access procedures, and the preamble mapping indication is configured separately for the at least two random access procedures.

For example, for the resources assignment for normal random access procedure and NTN-specific random access procedure in a NTN, if the ROs defined for normal PRACH transmission are shared with NTN-specific PRACH transmission, the SSB to RO mapping for normal PRACH transmission is reused. The number of preambles per SSB can be separately configured considering different preambles should be used by the two random access procedures.

As an example, a separate parameter PreamblesPerSSB-NTN is introduced for indication of the number of preambles per SSB for NTN-specific random access procedure, while the number of SSBs per RO can be determined by the first part of the existing parameter ssb-perRACH-OccasionAndCB-PreamblesPerSSB.

In an embodiment, the at least one random access procedure comprises at least two random access procedures, and the SSB mapping indication is configured separately for the at least two random access procedures.

In an embodiment, even if the ROs defined for normal PRACH transmission are shared with NTN-specific PRACH transmission, the SSB to RO mapping can be separately configured, since each PRACH transmission in NTN-specific random access procedure can be independent from the PRACH transmission in normal random access procedure in NTN.

As an example, a parameter ssb-perRACH-OccasionAndCB-PreamblesPerSSB-NTN can be included in the RACH-ConfigCommon IE to determine the number of SSBs mapped to each RO and the number of preambles per SSB for the NTN-specific random access procedure.

In an embodiment, the SSB mapping indication is configured in a way that ROs mapped in the SSB mapping indication configured for the NTN-specific random access procedure are a subset of ROs mapped in the SSB mapping indication configured for the normal random access procedure.

In the embodiment, only a subset of the ROs defined for normal random access procedure are used by NTN-specific random access procedure, and thus the SSB to RO mapping can be separately configured so that only the subset of ROs that are used by NTN-specific random access procedure is considered in the SSB to RO mapping.

In an embodiment, the determining unit 1510 may be configured to determine the RO used by the terminal device in transmitting the RACH preamble according to the received RACH preamble, and determine a SSB to which the determined RO is mapped according the SSB mapping indication. In an embodiment, the terminal device may transmit a RACH preamble on more than one RO, or transmit more than one RACH preamble on more than one RO. The RACH preamble received by the receiving unit 1530 comprises one or more preambles from the terminal device. For example, the terminal device may transmit a first RACH preamble and a second RACH preamble which is a complex conjugate of the first RACH preamble in a NTN-specific random access procedure. The terminal device determines the SSB with the best measurement, determines the RO according to the SSB mapping indication, and then transmits the one or more RACH preamble on the RO and one or more ROs following the RO. In the embodiment, the determining unit 1510 may determine a plurality of ROs according to the received RACH preamble. The determining unit 1510 uses one or more of the plurality of ROs in determining the SSB. In an embodiment, the first RO of the plurality of ROs is used in determining the SSB in the determining unit 1510.

In an example, when multiple ROs for normal random access procedure are used for single NTN-specific PRACH transmission, only one of the multiple ROs are counted for SSB to RO mapping and the remaining one or more ROs used for this single NTN-specific PRACH transmission are mapped to same SSB as the one counted for SSB to RO mapping for NTN-specific random access procedure.

As an example, if 2 normal ROs are used for an NTN-specific PRACH transmission with double PRACH sequence (each sequence is transmitted in each one of the ROs), only the 1st RO is counted for SSB to RO mapping and the 2nd RO is assumed to have same SSBs mapped as the 1st RO.

In another embodiment, when the normal random access procedure and NTN-specific random access procedure does not coexist in one cell in the NTN, the signaling for SSB to RO mapping for normal random access procedure is reused for NTN, but a separate IE can be introduced for NTN-specific random access procedure. E.g., RACH-ConfigCommonNTN can be used for NTN-specific random access procedure similar to RACH-ConfigCommon for normal random access procedure.

In an embodiment, the at least one random access procedure further comprise at least one second type of random access procedure in a Terrestrial Network (TN). That is, the TN and the NTN coexist in one cell. The at least one random access procedure may be at least one random access procedure in NTN and at least one random access procedure in TN.

In an embodiment, the at least one second type of random access procedure comprises a 4-step random access procedure and/or a 2-step random access procedure in TN.

In an embodiment, the preamble mapping indication is configured separately for the at least one random access procedure in NTN and the at least one random access procedure in TN.

In an embodiment, the ROs are shared between TN and NTN, the SSB to RO mapping for NTN is reused from TN and the number of preambles per SSB is separately configured.

As an example, CB-PreamblesPerSSB-NTN is separately configured to indicate the number of preambles per SSB for NTN on top of the number of preambles per SSB for TN indicated by the 2^{nd} part of ssb-perRA CH-OccasionAndCB-PreamblesPerSSB.

In an embodiment, the preamble mapping indication is configured in a way that a sum of the number of preambles configured for the at least two random access procedures for one RO is no more than a total number of preambles for the one RO.

For example, the number preambles per SSB for NTN X₂ multiplied by the number of SSBs per PRACH occasion for TN Y1 should be no more than the total number of preambles for the PRACH occasion Tₐₗₗ subtracted by the number of preambles in the PRACH occasion for TN T_{TN}, i.e., X₂*Y₁≤Tₐₗₗ−T_{TN}. T_{TN}=X1*Y₁ where X₁ is the number of preambles per SSB for TN.

In the embodiment, only a part of the ROs defined for TN are used by NTN network, and the SSB to RO mapping can be separately configured so that only the subset of ROs that are used by NTN RA is considered in the SSB to RO mapping.

For example, ssb-perRACH-OccasionAndCB-PreamblesPerSSB can be assumed to be the parameter of indication of SSB to RO mapping for TN, and a parameter ssb-perRACH-OccasionAndCB-PreamblesPerSSB-NTN additionally introduced can be the parameter of indication of the SSB to RO mapping for NTN.

In another embodiment, when the TN and NTN coexist in one cell, separate set of ROs are configured for NTN, and separate SSB to RO mapping for TN and NTN are needed.

In another embodiment, when multiple PRACH occasions for TN are used for single NTN PRACH transmission, only one of the multiple PRACH occasions (e.g., the first RO) are counted for SSB to RO mapping and the remaining one or more PRACH occasions used for this single PRACH transmission in NTN are mapped to same SSBs as the one counted for SSB to RO mapping for RA in NTN.

As an example, if 2 normal ROs are used for the transmission of a PRACH transmission with double PRACH sequence (each sequence is transmitted in each one of the ROs) in NTN, only the 1^{st} RO is counted for SSB to RO mapping and the 2^{nd} RO is assumed to have same SSBs mapped as the 1^{st} RO.

In another embodiment, when the TN and NTN does not coexist in one cell, the signaling for SSB to RO mapping for normal random access procedure is reused for a NTN random access procedure, but a separate IE can be introduced. E.g., RACH-ConfigCommonNTN can be used for NTN similar to RACH-ConfigCommon for TN.

The units 1510-1530 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 13.

FIG. 16 is a block diagram of a network device 1600 according to another embodiment of the present disclosure.

The network device 1600 includes a transceiver 1610, a processor 1620 and a memory 1630. The memory 1630 contains instructions executable by the processor 1620 whereby the network device 1600 is operative to perform the actions, e.g., of the procedure described earlier in conjunction with FIG. 13. Particularly, the memory 1630 contains instructions executable by the processor 1620 whereby the network device 1600 is operative to determine a RACH configuration according to at least one random access procedure, to transmit the RACH configuration, and to receive a RACH preamble which is transmitted according to the RACH configuration from a terminal device.

In an embodiment, the memory 1630 contains instructions executable by the processor 1620 whereby the network device 1600 is further operative to determine the RO used by the terminal device in transmitting the RACH preamble according to the received RACH preamble, and to determine a SSB to which the determined RO is mapped according the SSB mapping indication.

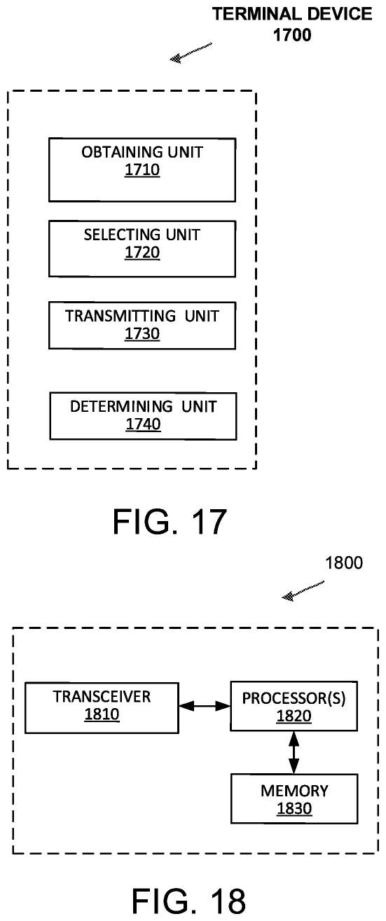

Correspondingly to the method 1400 as described above, a terminal device is provided. FIG. 17 is a block diagram of a terminal device 1700 according to an embodiment of the present disclosure.

As shown in FIG. 17, the terminal device 1700 includes an obtaining unit 1710 configured to obtain a RACH configuration from a network device. The RACH configuration is determined according to at least one random access procedure, and comprises a preamble mapping indication indicating mapping of RACH preambles to SSBs and a SSB mapping indication indicating the mapping of SSBs to ROs.

The terminal device 1700 may further include a selecting unit 1720 configured to select a RACH preamble and a RO according to the RACH configuration, and a transmitting unit 1730 configured to transmit the RACH preamble on the RO to the network device.

In an embodiment, the at least one random access procedure comprises at least two random access procedures, and at least one of the preamble mapping indication and the SSB mapping indication is configured separately for the at least two random access procedures.

In an embodiment, the at least one random access procedure comprise at least one first type of random access procedure in a NTN.

For example, the at least one first type of random access procedure comprises a normal random access procedure and/or a NTN-specific random access procedure. In an embodiment, the normal random access procedure is a random access procedure with pre-compensation of TA and/or frequency, and the NTN-specific random access procedure is a random access procedure without the pre-compensation.

In an embodiment, the at least one random access procedure comprises at least two random access procedures, and the preamble mapping indication is configured separately for the at least two random access procedures.

In an embodiment, the at least one random access procedure further comprise at least one second type of random access procedure in a TN. That is, the TN and the NTN coexist in one cell. The at least one random access procedure may be at least one random access procedure in NTN and at least one random access procedure in TN.

In an embodiment, the at least one second type of random access procedure comprises a 4-step random access procedure and/or a 2-step random access procedure in TN.

In an embodiment, the terminal device 1700 may further comprise a determining unit 1740 configured to determine a SSB according to the received RACH configuration, to determine a RO according to the SSB mapping indication in the received RACH configuration. In an embodiment, the terminal device may transmit a RACH preamble on more than one RO, or transmit more than one RACH preamble on more than one RO. For example, the terminal device may transmit a first RACH preamble and a second RACH preamble which is a complex conjugate of the first RACH preamble in a NTN-specific random access procedure. In the embodiment, the transmitting unit 1730 is configured to transmit the RACH preamble on the RO and one or more ROs following the RO.

The units 1710-1740 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 14.

FIG. 18 is a block diagram of a terminal device 1800 according to another embodiment of the present disclosure.

The terminal device 1800 includes a transceiver 1810, a processor 1820 and a memory 1830. The memory 1830 contains instructions executable by the processor 1820 whereby the terminal device 1800 is operative to perform the actions, e.g., of the procedure described earlier in conjunction with FIG. 14. Particularly, the memory 1830 contains instructions executable by the processor 1820 whereby the terminal device 1800 is operative to obtain a RACH configuration from a network device, to select a RACH preamble and a RO according to the RACH configuration, and to transmit the RACH preamble on the RO to the network device.

In an embodiment, the memory 1830 contains instructions executable by the processor 1820 whereby the terminal device 1800 is further operative to determine a SSB according to the received RACH configuration, and determine a RO according to the SSB mapping indication in the received RACH configuration. In the embodiment, the memory 1830 contains instructions executable by the processor 1820 whereby the terminal device 1800 is further operative to transmit the RACH preamble on the RO and one or more ROs following the RO.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1620 causes the network device 1600 to perform the actions, e.g., of the procedure described earlier in conjunction with FIG. 13; or code/computer readable instructions, which when executed by the processor 1820 causes the terminal device 1800 to perform the actions, e.g., of the procedure described earlier in conjunction with FIG. 14.

The computer program product may be configured as a computer program code structured in computer program modules. The computer program modules could essentially perform the actions of the flow illustrated in FIG. 13 or FIG. 14.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

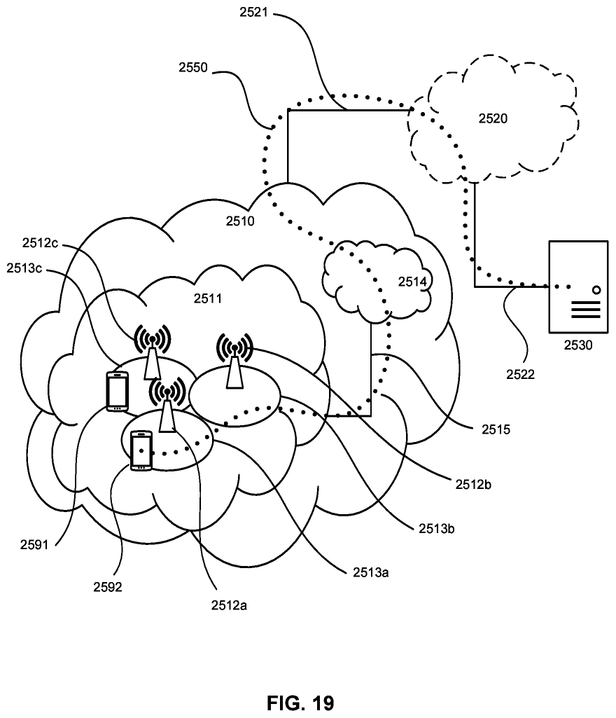

With reference to FIG. 19, in accordance with an embodiment, a communication system includes a telecommunication network 2510, such as a 3GPP-type cellular network, which comprises an access network 2511, such as a radio access network, and a core network 2514. The access network 2511 comprises a plurality of base stations 2512a, 2512b, 2512c, such as NBs, eNBs, gNBs or other types of wireless access points, each defining a corresponding coverage area 2513a, 2513b, 2513c. Each base station 2512a, 2512b, 2512c is connectable to the core network 2514 over a wired or wireless connection 2515. A first UE 2591 located in a coverage area 2513c is configured to wirelessly connect to, or be paged by, the corresponding base station 2512c. A second UE 2592 in a coverage area 2513a is wirelessly connectable to the corresponding base station 2512a. While a plurality of UEs 2591, 2592 are illustrated in this example, the disclosed embodiments are equally applicable to a situation where a sole UE is in the coverage area or where a sole UE is connecting to the corresponding base station 2512.

The telecommunication network 2510 is itself connected to a host computer 2530, which may be embodied in the hardware and/or software of a standalone server, a cloud-implemented server, a distributed server or as processing resources in a server farm. The host computer 2530 may be under the ownership or control of a service provider, or may be operated by the service provider or on behalf of the service provider. Connections 2521 and 2522 between the telecommunication network 2510 and the host computer 2530 may extend directly from the core network 2514 to the host computer 2530 or may go via an optional intermediate network 2520. An intermediate network 2520 may be one of, or a combination of more than one of, a public, private or hosted network; the intermediate network 2520, if any, may be a backbone network or the Internet; in particular, the intermediate network 2520 may comprise two or more sub-networks (not shown).

The communication system of FIG. 19 as a whole enables connectivity between the connected UEs 2591, 2592 and the host computer 2530. The connectivity may be described as an over-the-top (OTT) connection 2550. The host computer 2530 and the connected UEs 2591, 2592 are configured to communicate data and/or signaling via the OTT connection 2550, using the access network 2511, the core network 2514, any intermediate network 2520 and possible further infrastructure (not shown) as intermediaries. The OTT connection 2550 may be transparent in the sense that the participating communication devices through which the OTT connection 2550 passes are unaware of routing of uplink and downlink communications. For example, the base station 2512 may not or need not be informed about the past routing of an incoming downlink communication with data originating from the host computer 2530 to be forwarded (e.g., handed over) to a connected UE 2591. Similarly, the base station 2512 need not be aware of the future routing of an outgoing uplink communication originating from the UE 2591 towards the host computer 2530.

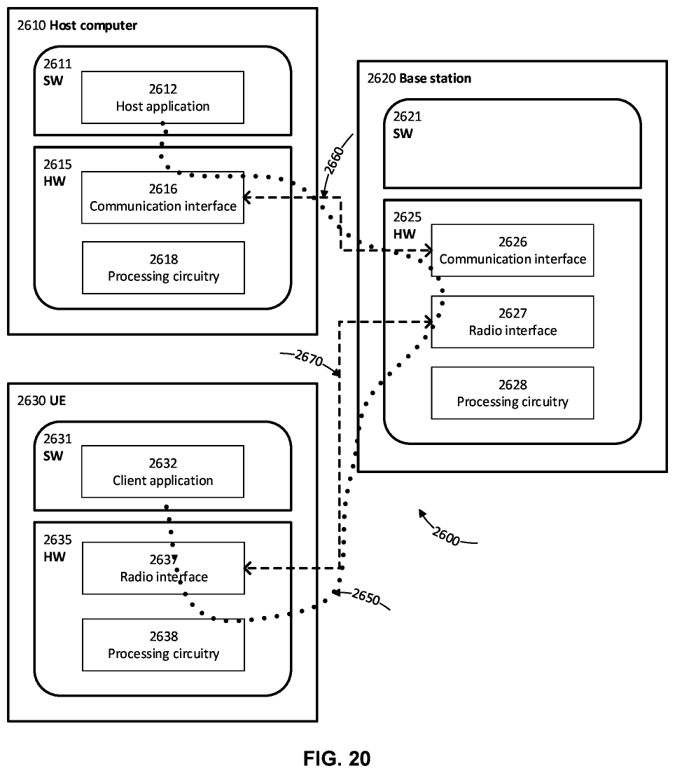

Example implementations, in accordance with an embodiment, of the UE, base station and host computer discussed in the preceding paragraphs will now be described with reference to FIG. 20. In a communication system 2600, a host computer 2610 comprises hardware 2615 including a communication interface 2616 configured to set up and maintain a wired or wireless connection with an interface of a different communication device of the communication system 2600. The host computer 2610 further comprises a processing circuitry 2618, which may have storage and/or processing capabilities. In particular, the processing circuitry 2618 may comprise one or more programmable processors, application-specific integrated circuits, field programmable gate arrays or combinations of these (not shown) adapted to execute instructions. The host computer 2610 further comprises software 2611, which is stored in or accessible by the host computer 2610 and executable by the processing circuitry 2618. The software 2611 includes a host application 2612. The host application 2612 may be operable to provide a service to a remote user, such as UE 2630 connecting via an OTT connection 2650 terminating at the UE 2630 and the host computer 2610. In providing the service to the remote user, the host application 2612 may provide user data which is transmitted using the OTT connection 2650.

The communication system 2600 further includes a base station 2620 provided in a telecommunication system and comprising hardware 2625 enabling it to communicate with the host computer 2610 and with the UE 2630. The hardware 2625 may include a communication interface 2626 for setting up and maintaining a wired or wireless connection with an interface of a different communication device of the communication system 2600, as well as a radio interface 2627 for setting up and maintaining at least a wireless connection 2670 with the UE 2630 located in a coverage area (not shown in FIG. 20) served by the base station 2620. The communication interface 2626 may be configured to facilitate a connection 2660 to the host computer 2610. The connection 2660 may be direct or it may pass through a core network (not shown in FIG. 20) of the telecommunication system and/or through one or more intermediate networks outside the telecommunication system. In the embodiment shown, the hardware 2625 of the base station 2620 further includes a processing circuitry 2628, which may comprise one or more programmable processors, application-specific integrated circuits, field programmable gate arrays or combinations of these (not shown) adapted to execute instructions. The base station 2620 further has software 2621 stored internally or accessible via an external connection.

The communication system 2600 further includes the UE 2630 already referred to. Its hardware 2635 may include a radio interface 2637 configured to set up and maintain a wireless connection 2670 with a base station serving a coverage area in which the UE 2630 is currently located. The hardware 2635 of the UE 2630 further includes a processing circuitry 2638, which may comprise one or more programmable processors, application-specific integrated circuits, field programmable gate arrays or combinations of these (not shown) adapted to execute instructions. The UE 2630 further comprises software 2631, which is stored in or accessible by the UE 2630 and executable by the processing circuitry 2638. The software 2631 includes a client application 2632. The client application 2632 may be operable to provide a service to a human or non-human user via the UE 2630, with the support of the host computer 2610. In the host computer 2610, an executing host application 2612 may communicate with the executing client application 2632 via the OTT connection 2650 terminating at the UE 2630 and the host computer 2610. In providing the service to the user, the client application 2632 may receive request data from the host application 2612 and provide user data in response to the request data. The OTT connection 2650 may transfer both the request data and the user data. The client application 2632 may interact with the user to generate the user data that it provides.

It is noted that the host computer 2610, the base station 2620 and the UE 2630 illustrated in FIG. 20 may be similar or identical to the host computer 2530, one of base stations 2512a, 2512b, 2512c and one of UEs 2591, 2592 of FIG. 19, respectively. This is to say, the inner workings of these entities may be as shown in FIG. 20 and independently, the surrounding network topology may be that of FIG. 19.

In FIG. 20, the OTT connection 2650 has been drawn abstractly to illustrate the communication between the host computer 2610 and the UE 2630 via the base station 2620, without explicit reference to any intermediary devices and the precise routing of messages via these devices. Network infrastructure may determine the routing, which it may be configured to hide from the UE 2630 or from the service provider operating the host computer 2610, or both. While the OTT connection 2650 is active, the network infrastructure may further take decisions by which it dynamically changes the routing (e.g., on the basis of load balancing consideration or reconfiguration of the network).

Wireless connection 2670 between the UE 2630 and the base station 2620 is in accordance with the teachings of the embodiments described throughout this disclosure. One or more of the various embodiments improve the performance of OTT services provided to the UE 2630 using the OTT connection 2650, in which the wireless connection 2670 forms the last segment. More precisely, the teachings of these embodiments may improve the radio resource utilization and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 2650 between the host computer 2610 and the UE 2630, in response to variations in the measurement results. The measurement procedure and/or the network functionality for reconfiguring the OTT connection 2650 may be implemented in software 2611 and hardware 2615 of the host computer 2610 or in software 2631 and hardware 2635 of the UE 2630, or both. In embodiments, sensors (not shown) may be deployed in or in association with communication devices through which the OTT connection 2650 passes; the sensors may participate in the measurement procedure by supplying values of the monitored quantities exemplified above, or supplying values of other physical quantities from which the software 2611, 2631 may compute or estimate the monitored quantities. The reconfiguring of the OTT connection 2650 may include message format, retransmission settings, preferred routing etc.; the reconfiguring need not affect the base station 2620, and it may be unknown or imperceptible to the base station 2620. Such procedures and functionalities may be known and practiced in the art. In certain embodiments, measurements may involve proprietary UE signaling facilitating the host computer 2610's measurements of throughput, propagation times, latency and the like. The measurements may be implemented in that the software 2611 and 2631 causes messages to be transmitted, in particular empty or ‘dummy’ messages, using the OTT connection 2650 while it monitors propagation times, errors etc.

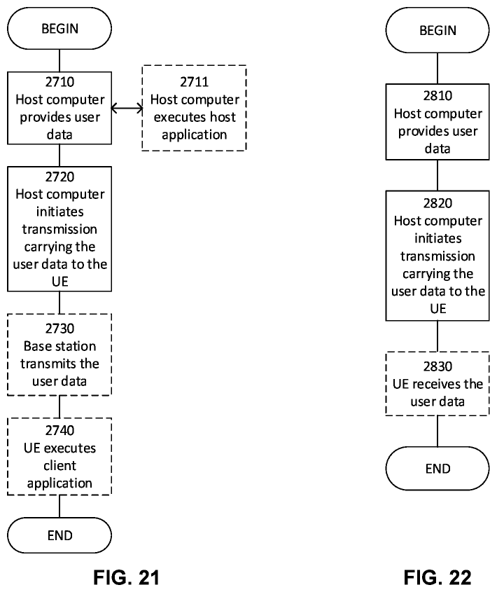

FIG. 21 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 21 will be included in this section. In step 2710, the host computer provides user data. In substep 2711 (which may be optional) of step 2710, the host computer provides the user data by executing a host application. In step 2720, the host computer initiates a transmission carrying the user data to the UE. In step 2730 (which may be optional), the base station transmits to the UE the user data which was carried in the transmission that the host computer initiated, in accordance with the teachings of the embodiments described throughout this disclosure. In step 2740 (which may also be optional), the UE executes a client application associated with the host application executed by the host computer.

FIG. 22 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 22 will be included in this section. In step 2810 of the method, the host computer provides user data. In an optional substep (not shown) the host computer provides the user data by executing a host application. In step 2820, the host computer initiates a transmission carrying the user data to the UE. The transmission may pass via the base station, in accordance with the teachings of the embodiments described throughout this disclosure. In step 2830 (which may be optional), the UE receives the user data carried in the transmission.

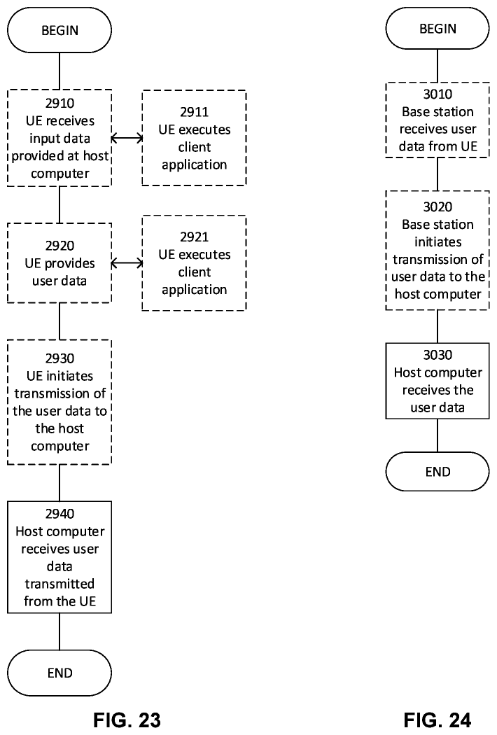

FIG. 23 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 23 will be included in this section. In step 2910 (which may be optional), the UE receives input data provided by the host computer. Additionally or alternatively, in step 2920, the UE provides user data. In substep 2921 (which may be optional) of step 2920, the UE provides the user data by executing a client application. In substep 2911 (which may be optional) of step 2910, the UE executes a client application which provides the user data in reaction to the received input data provided by the host computer. In providing the user data, the executed client application may further consider user input received from the user. Regardless of the specific manner in which the user data was provided, the UE initiates, in substep 2930 (which may be optional), transmission of the user data to the host computer. In step 2940 of the method, the host computer receives the user data transmitted from the UE, in accordance with the teachings of the embodiments described throughout this disclosure.

FIG. 24 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 24 will be included in this section. In step 3010 (which may be optional), in accordance with the teachings of the embodiments described throughout this disclosure, the base station receives user data from the UE. In step 3020 (which may be optional), the base station initiates transmission of the received user data to the host computer. In step 3030 (which may be optional), the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1-26. (canceled)

27. A method in a network device, comprising:
determining a Random Access Channel (RACH) configuration according to at least one random access procedure, wherein the RACH configuration comprises a preamble mapping indication indicating mapping of RACH preambles to Synchronization Signal/Physical Broadcast Channels (SSBs) and a SSB mapping indication indicating mapping of SSBs to RACH Occasions (ROs),
transmitting the RACH configuration, and
receiving a RACH preamble which is transmitted according to the RACH configuration from a terminal device.

28. The method of claim 27, wherein the at least one random access procedure comprises at least two random access procedures, and wherein at least one of the preamble mapping indication and the SSB mapping indication is configured separately for the at least two random access procedures.

29. The method of claim 28, wherein the at least one random access procedure further comprise at least one second type of random access procedure in a Terrestrial Network (TN); wherein the at least one second type of random access procedure comprises a 4-step random access procedure and/or a 2-step random access procedure.

30. The method of claim 29, wherein the preamble mapping indication is configured in a way that a sum of the number of preambles configured for the at least two random access procedures for one RO is no more than a total number of preambles for the one RO.

31. The method of claim 27, wherein the at least one random access procedure comprise at least one first type of random access procedure in a Non-Terrestrial Network (NTN).

32. The method of claim 27, wherein the at least one first type of random access procedure comprises a normal random access procedure and/or a NTN-specific random access procedure.

33. The method of claim 32, wherein the normal random access procedure is a random access procedure with pre-compensation of Time-Advanced (TA) and/or frequency, and the NTN-specific random access procedure is a random access procedure without the pre-compensation.

34. The method of claim 32, wherein the SSB mapping indication is configured in a way that ROs mapped in the SSB mapping indication configured for the specific random access procedure are a subset of ROs mapped in the SSB mapping indication configured for the normal random access procedure.

35. The method of claim 27, further comprising:
determining the RO used by the terminal device in transmitting the RACH preamble according to the received RACH preamble, and
determining a SSB to which the determined RO is mapped according the SSB mapping indication.

36. The method of claim 35, wherein if a plurality of ROs is determined according to the received RACH preamble, one or more of the plurality of ROs are used in determining the SSB; wherein the one or more of the plurality of ROs is the first one of the plurality of Ros; wherein the RACH preamble comprises one or more preambles from the terminal device.

37. A method in a terminal device, comprising:
obtaining a Random Access Channel (RACH) configuration from a network device, wherein the RACH configuration is determined according to at least one random access procedure, and comprises a preamble mapping indication indicating mapping of RACH preambles to Synchronization Signal/Physical Broadcast Channels (SSBs) and a SSB mapping indication indicating the mapping of SSBs to RACH Occasions (ROs),
selecting a RACH preamble and a RO according to the RACH configuration; and
transmitting the RACH preamble on the RO to the network device.

38. The method of claim 37, wherein the at least one random access procedure comprises at least two random access procedure, and wherein at least one of the preamble mapping indication and the SSB mapping indication is configured separately for the at least two random access procedures.

39. The method of claim 37, wherein the at least one random access procedure comprise at least one first type of random access procedure in a Non-Terrestrial Network (NTN).

40. The method of claim 37, wherein the at least one first type of random access procedure comprises a normal random access procedure and/or a NTN-specific random access procedure.

41. The method of claim 40, wherein the normal random access procedure is a random access procedure with pre-compensation of Time-Advanced (TA) and/or frequency, and the NTN-specific random access procedure is a random access procedure without the pre-compensation.

42. The method of claim 37, wherein the at least one random access procedure further comprise at least one second type of random access procedure in a Terrestrial network.

43. The method of claim 42, wherein the at least one second type of random access procedure comprises a 4-step random access procedure and/or a 2-step random access procedure.

44. The method of claim 37, wherein selecting a RACH preamble and a RO according to the RACH configuration comprises:
determining a SSB according to the received RACH configuration; and
determining a RO according to the SSB mapping indication in the received RACH configuration; and
wherein transmitting the RACH preamble on the RO to the network device comprises transmitting the RACH preamble on the RO and one or more ROs following the RO.

45. The method of claim 37, wherein the RACH preamble comprises one or more preambles.

46. A terminal device, comprising a transceiver, a processor and a memory, the memory comprising instructions executable by the processor whereby the terminal device is operative to perform of:
obtaining a Random Access Channel (RACH) configuration from a network device, wherein the RACH configuration is determined according to at least one random access procedure, and comprises a preamble mapping indication indicating mapping of RACH preambles to Synchronization Signal/Physical Broadcast Channels (SSBs) and a SSB mapping indication indicating the mapping of SSBs to RACH Occasions (ROs),
selecting a RACH preamble and a RO according to the RACH configuration; and
transmitting the RACH preamble on the RO to the network device.
